(19) United States
(12) Patent Application Publication
(10) Pub. No.: US 2016/0342029 A1
(43) Pub. Date: Nov. 24, 2016

(54) LIQUID CRYSTAL DISPLAY AND MANUFACTURING METHOD THEREOF

(71) Applicant: Samsung Display Co., Ltd., Yongin-si (KR)

(72) Inventor: Ho LIM, Suwon-si (KR)

(21) Appl. No.: 15/042,039

(22) Filed: Feb. 11, 2016

(30) Foreign Application Priority Data
May 22, 2015 (KR) 10-2015-0072171

(51) Int. Cl. G02F 1/1337; C09K 19/38; G02F 1/1341; G02F 1/1333; G02F 1/1368

(52) U.S. Cl. CPC G02F 1/133711; G02F 1/133377; G02F 1/1368; G02F 1/133345; G02F 1/133788; G02F 1/1341; C09K 19/3823; C09K 19/3809; G02F 2001/133726; G02F 2001/133749

(57) ABSTRACT

A liquid crystal display includes a substrate; a thin film transistor disposed on the substrate; a pixel electrode disposed on the thin film transistor; a roof layer facing the pixel electrode; and a liquid crystal layer having a plurality of microcavities that include a liquid crystal molecule and a reactive mesogen between the pixel electrode and the roof layer, wherein the liquid crystal molecule has a pretilt angle due to a protrusion formed in a region of the plurality of microcavities adjacent to the pixel electrode.

This application claims priority to Korean Patent Application No. 10-2015-0072171 filed on May 22, 2015, and all the benefits accruing therefrom under 35 U.S.C. §119, the entire content of which is hereby incorporated by reference.

### BACKGROUND

(a) Technical Field

The present invention relates to a liquid crystal display and a manufacturing method thereof.

(b) Description of the Related Art

A liquid crystal display is one of the most widely used flat panel display devices. A liquid crystal display includes two display panels where field generating electrodes such as a pixel electrode and a common electrode are formed, with a liquid crystal layer interposed therebetween.

The liquid crystal display generates an electric field in a liquid crystal layer by applying a voltage to the field generating electrodes to determine the orientations of liquid crystal molecules of the liquid crystal layer and controlling the polarization of incident light, thereby displaying an image.

A technique for forming a cavity for each pixel and filling the cavity with liquid crystal to produce a display has been developed for liquid crystal displays. The technique forms a sacrificial layer with an organic material instead of forming an upper plate on a lower plate, forms a supporting member on an upper portion, removes the sacrificial layer and fills liquid crystal in an empty space formed by the removal of the sacrificial layer through a liquid crystal injection hole to manufacture the display.

In such liquid crystal displays, since an alignment material is injected into the plurality of cavities, it is significantly more difficult to form the alignment layer in comparison to a liquid crystal display device produced using two display panels.

The above information disclosed in this Background section is only to enhance the understanding of the background of the invention, and therefore it may contain information that does not form the prior art that is already known in this country to a person of ordinary skill in the art.

### SUMMARY

The present invention provides an efficient process for improving an alignment property in a liquid crystal display and a method of manufacturing a liquid crystal display.

In an exemplary embodiment, a liquid crystal display includes a substrate; a thin film transistor disposed on the substrate; a pixel electrode disposed on the thin film transistor; a roof layer facing the pixel electrode; a liquid crystal layer, having a plurality of microcavities, disposed between the pixel electrode and the roof layer, the liquid crystal layer a liquid crystal molecule and a reactive mesogen, where the liquid crystal molecule has a pretilt angle due to a protrusion (or bump) formed in a region of the plurality of microcavities adjacent to the pixel electrode.

In another exemplary embodiment, the protrusion may include an alignment polymer produced by polymerizing the reactive mesogen included in the liquid crystal layer.

In yet another exemplary embodiment, a common electrode disposed between a microcavity in the liquid crystal layer and the roof layer may be further included, and the protrusion may be positioned at an upper surface of the pixel electrode and a lower surface of the common electrode facing each other inside the microcavity.

In another exemplary embodiment, a lower insulating layer disposed between the common electrode and the roof layer may be further included.

In yet another exemplary embodiment, the protrusion may include a polymer produced by polymerizing at least one compound selected from Chemical Formulas 1-1 to 1-14 by a ultraviolet irradiation (“UV”):

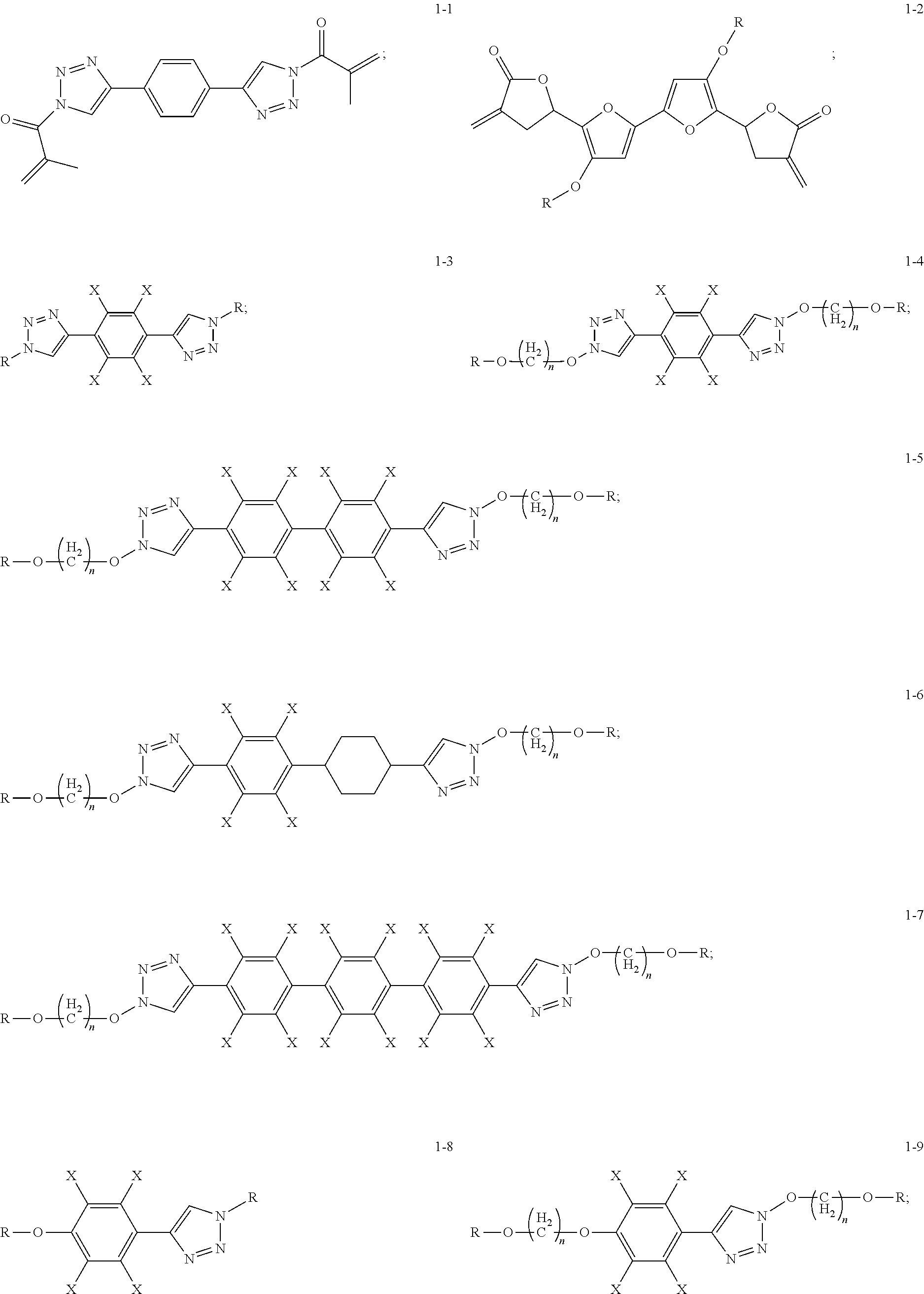

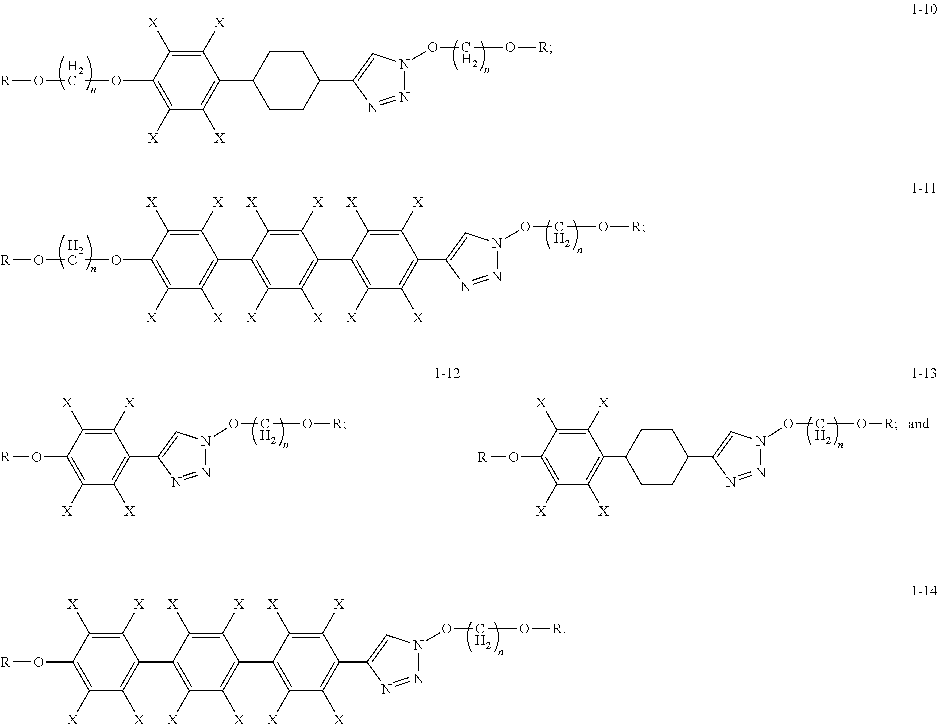

In an aspect of the exemplary embodiment, in Chemical Formulas 1-1 to 1-14:

n may be a number of 1 to 20;

X may be at least one of hydrogen (H), a methyl (CH₃) group, an ethylbenzene (CH₂ₙCH₃) group, fluorine (F), bromine (Br), iodine (I), a hydroxide (OH) group, an isopropyl (C₃H₇) group, an amine (NH₂) group and a cyano (CN) group; and

R may be at least one of

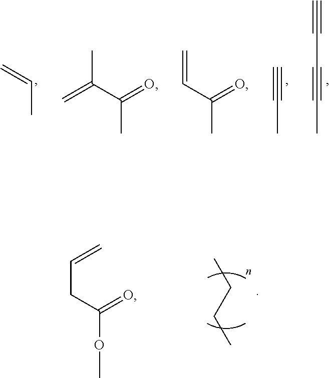

In another exemplary embodiment, the protrusion may include a polymer produced by polymerizing at least one compound selected from Chemical Formulas 2-1 to 2-17 using UV irradiation:

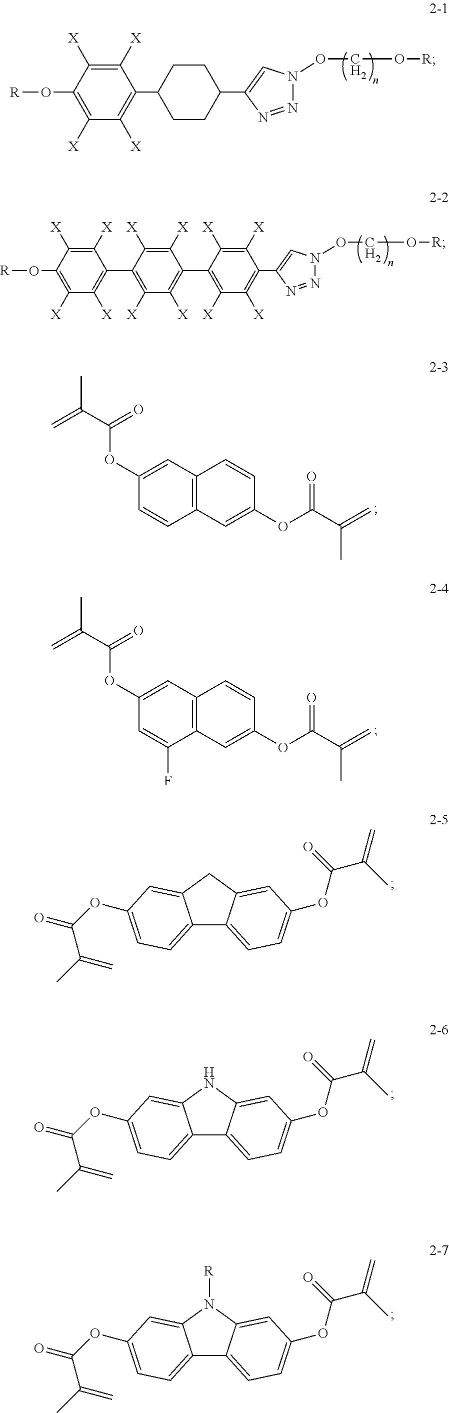

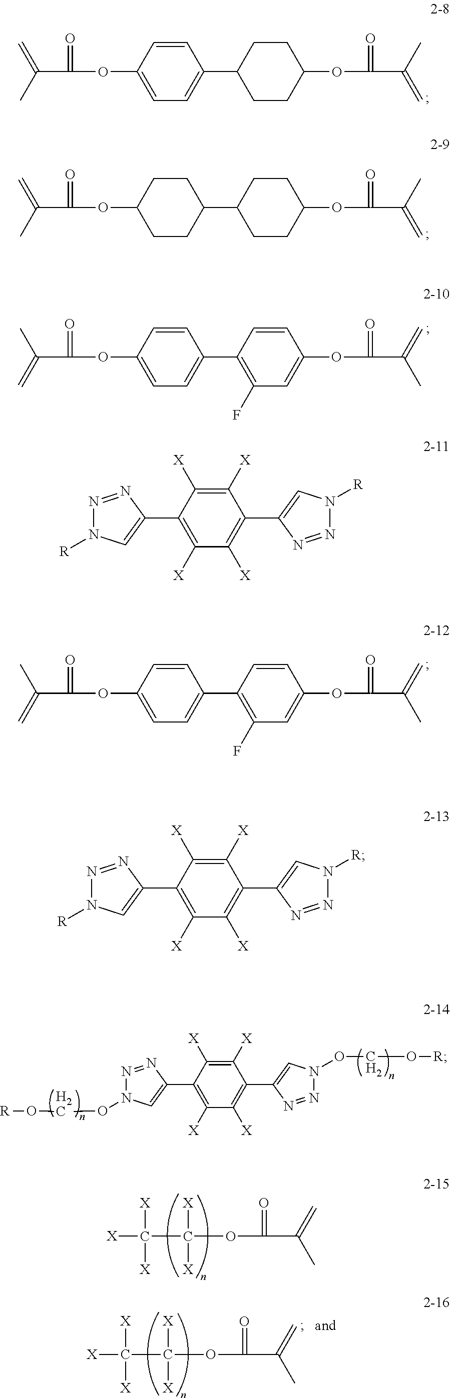

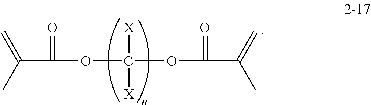

In an aspect of the exemplary embodiment, in Chemical Formulas 2-1 to 2-17:

n may be a number of 1 to 20;

X may be at least one of hydrogen (H), fluorine (F), chlorine (CO, bromine (Br), iodine (I), an amine NH₂ group and a hydroxide (OH) group, andR may be at least one of

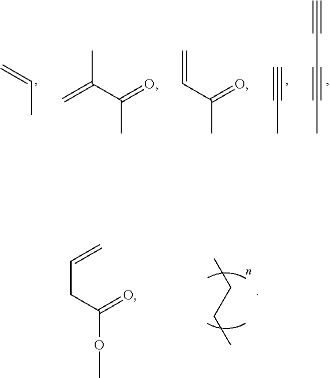

In another exemplary embodiment, the content of the reactive mesogen in the liquid crystal layer is less than about 150 parts per million (ppm).

In another exemplary embodiment, the alignment layer may not exist in the micro cavity.

In yet another exemplary embodiment, the liquid crystal layer may be pre-tilted with an angle of about 1 degree to about 2 degrees. In still another exemplary embodiment, a capping layer disposed on the roof layer may be further included, a trench between the plurality of microcavities may be formed, and the capping layer may cover the trench.

In another exemplary embodiment, the protrusion may be disposed directly on the surface of the pixel electrode.

In an exemplary embodiment, a manufacturing method of a display device includes forming a thin film transistor on a substrate; connecting a pixel electrode to the thin film transistor; forming a sacrificial layer on the pixel electrode; forming a roof layer on the sacrificial layer; removing the sacrificial layer to form a plurality of microcavities; injecting a mixture of a liquid crystal molecule and a reactive mesogen into the plurality of microcavities; and irradiating ultraviolet rays onto the mixture of the liquid crystal molecule and the reactive mesogen to form a protrusion in a region of the plurality of microcavities adjacent to the pixel electrode, where the injection of the mixture of the liquid crystal molecule and the reactive mesogen is performed in a state in which the surface of the pixel electrode facing the plurality of microcavities is exposed.

In another exemplary embodiment, the content of the reactive mesogen in the mixture of the liquid crystal and the reactive mesogen may be between about 2,000 parts per million (ppm) to about 10,000 ppm.

In yet another exemplary embodiment, the reactive mesogen may include at least one compound represented by Chemical Formulas 1-1 to 1-14:

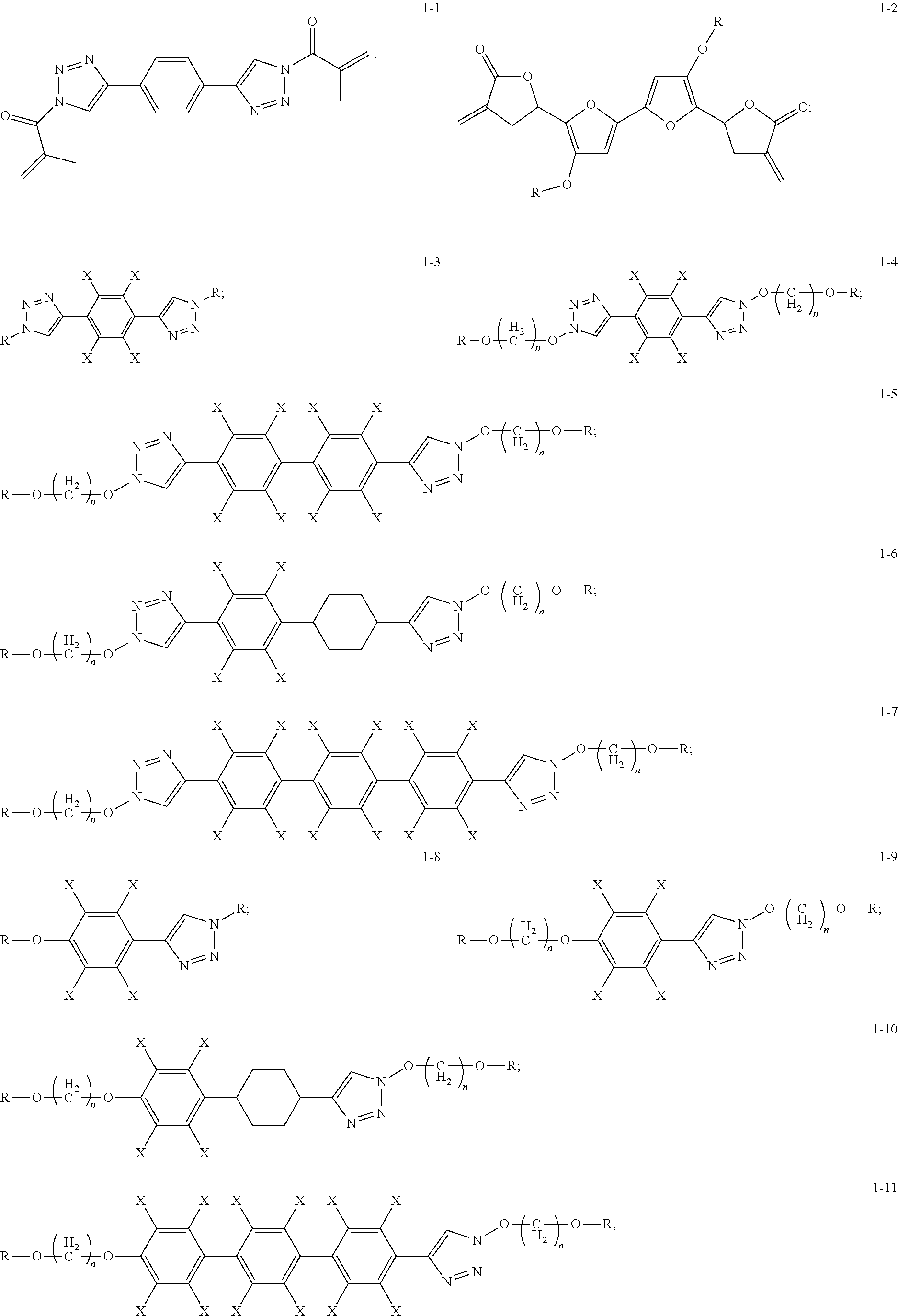

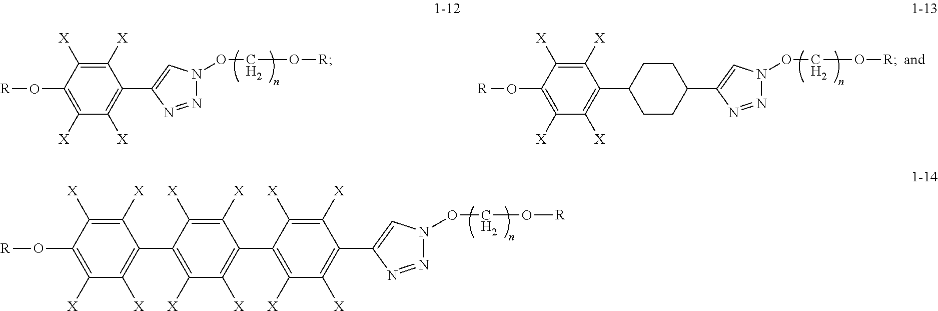

In an aspect of the exemplary embodiment, in Chemical Formulas 1-1 to 1-14:

n may be a number of 1 to 20:

X may be at least one of hydrogen (H), a methyl (CH₃) group, an ethylbenzene

(CH₂ₙCH₃) group, fluorine (F), bromine (Br), iodine (I), a hydroxide (OH) group, an isopropyl (C₃H₇) group, an amine (NH₂) group and a cyano (CN) group: and

R may be at least one of

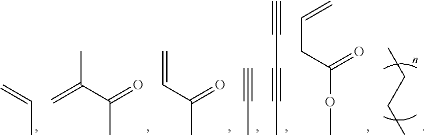

In an exemplary embodiment, the reactive mesogen may include at least one compound represented by Chemical Formula 2-1 to 2-17:

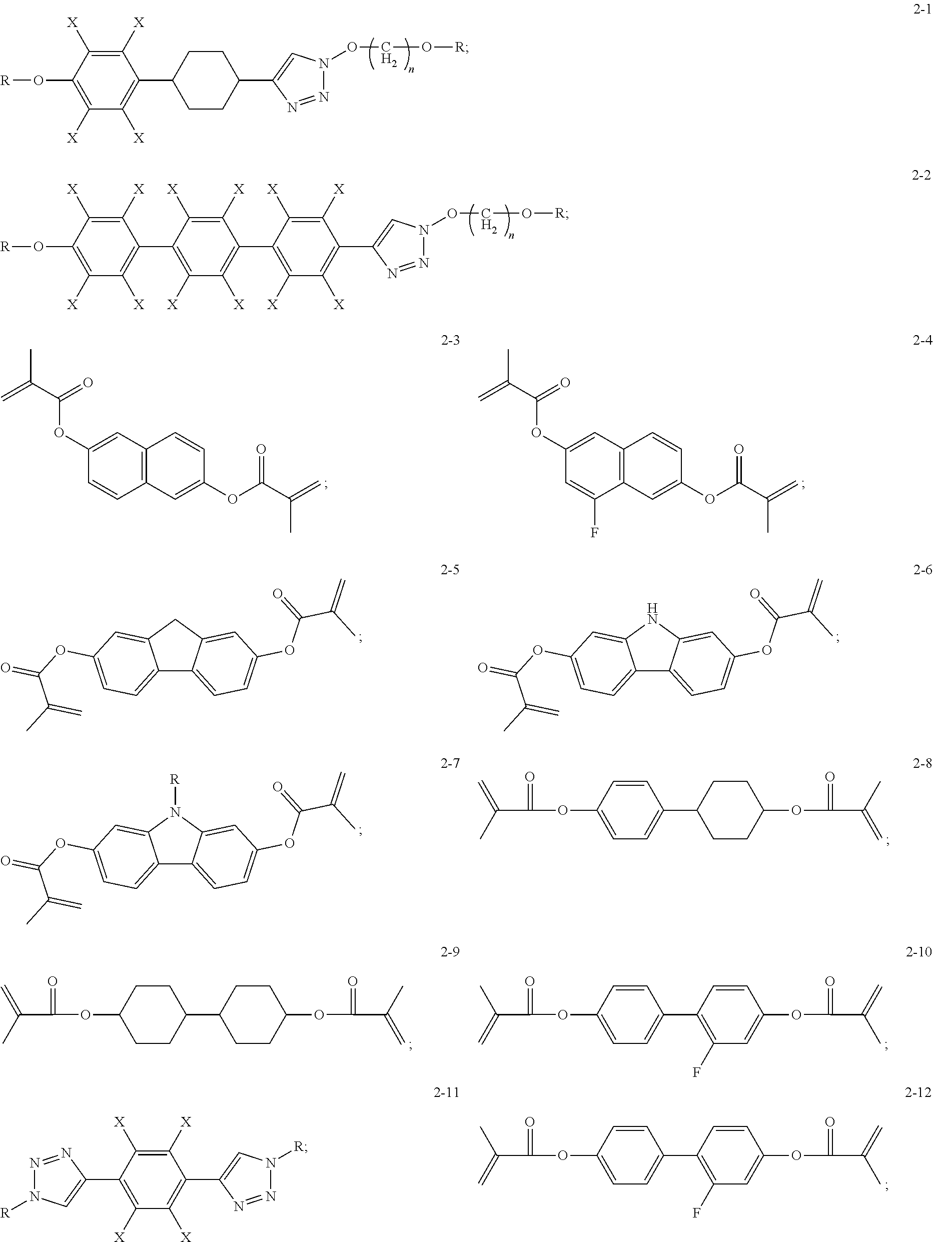

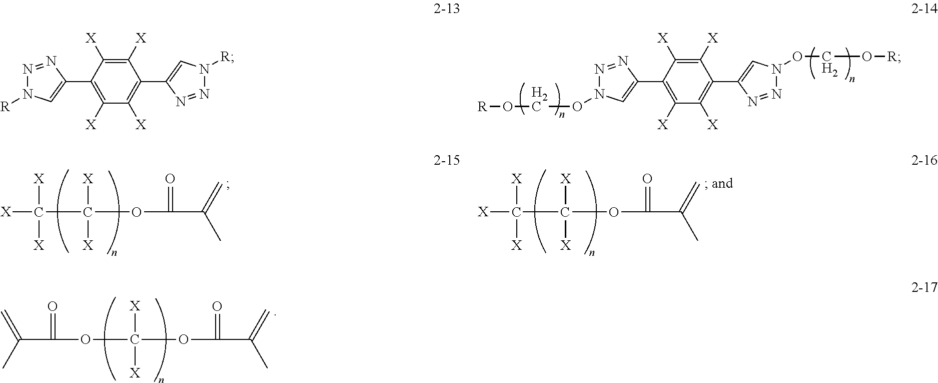

In an aspect of the exemplary embodiment, in Chemical Formulas 2-1 to 2-17:

n may be a number of 1 to 20;

X may be at least one of hydrogen (H), fluorine (F), chlorine (Cl), bromine (Br), iodine (I), an amine (NH₂) group and a hydroxide (OH) group; and

R may be at least one of

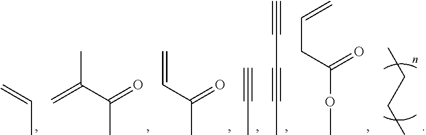

In an exemplary embodiment, the formation of the protrusion by irradiating ultraviolet rays onto the mixture of the liquid crystal molecule and the reactive mesogen may include irradiating first ultraviolet rays in a state of a non-electric field, and irradiating second ultraviolet rays in a state of an electric field to form a pretilt angle.

In another exemplary embodiment, after the irradiating second ultraviolet rays in a state of an electric field to form the pretilt angle, the method may further include irradiating a fluorescence ultraviolet light to remove non-reacted reactive mesogen in the microcavities.

In still another exemplary embodiment, the pretilt angle after the irradiating of second ultraviolet rays in a state of an electric field to form the pretilt angle may be about 1 degree to about 2 degrees.

In an exemplary embodiment, the content of the reactive mesogen in the liquid crystal layer after irradiating ultraviolet rays onto the mixture of the liquid crystal molecule and the reactive mesogen to form the protrusion may be less than about 150 parts per million.

In another exemplary embodiment, the method may further include forming a capping layer on the roof layer between the injection of the mixture of the liquid crystal molecule and the reactive mesogen to the microcavities and irradiating ultraviolet rays onto the mixture of the liquid crystal molecule and the reactive mesogen to form the protrusion.

In an exemplary embodiment of the liquid crystal display, by inducing the vertical alignment of the liquid crystal molecule through use of the reactive mesogen, unlike conventional methods for forming the conventional alignment layer, the process may be more efficient, the material costs may be reduced and a comparative or superior vertical alignment force may be obtained.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a top plan view of an exemplary embodiment of a display panel of a display unit;

FIG. 2 is a cross-sectional view taken along line II-II of FIG. 1;

FIG. 3 is a cross-sectional view taken along line of FIG. 1;

FIGS. 4 to 9 are process cross-sectional views of an exemplary embodiment of a display device;

FIG. 10 is a view schematically showing an exemplary embodiment of a process for forming a protrusion by irradiating an ultraviolet light onto a liquid crystal layer including a reactive mesogen;

FIG. 11 shows an image of an exemplary embodiment of a display device; and

FIG. 12 shows a surface image of an exemplary embodiment of a protrusion formed in a liquid crystal display.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. Now, an exemplary embodiment of a display device and a manufacturing method thereof will be described with reference to the accompanying drawings.

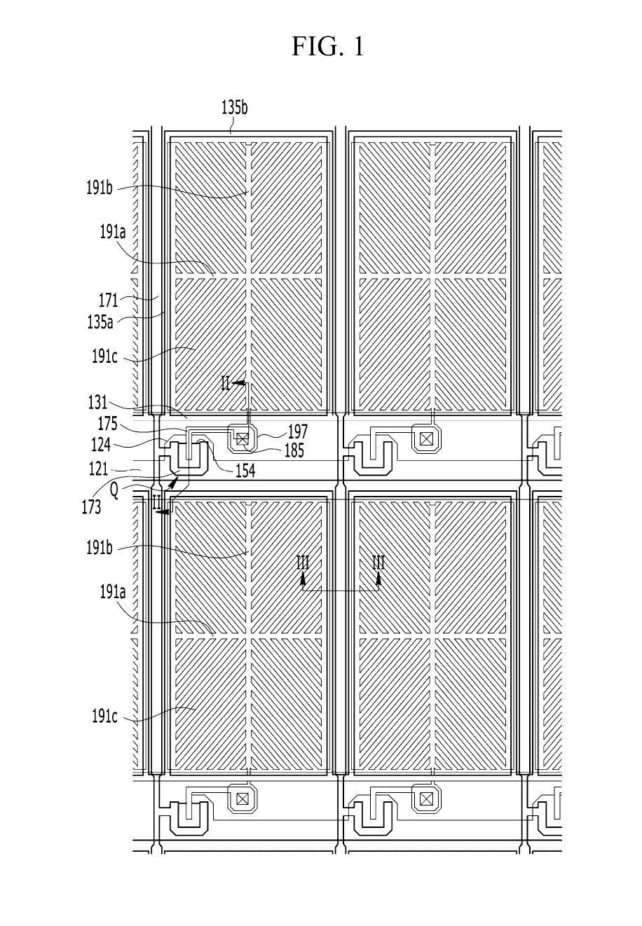

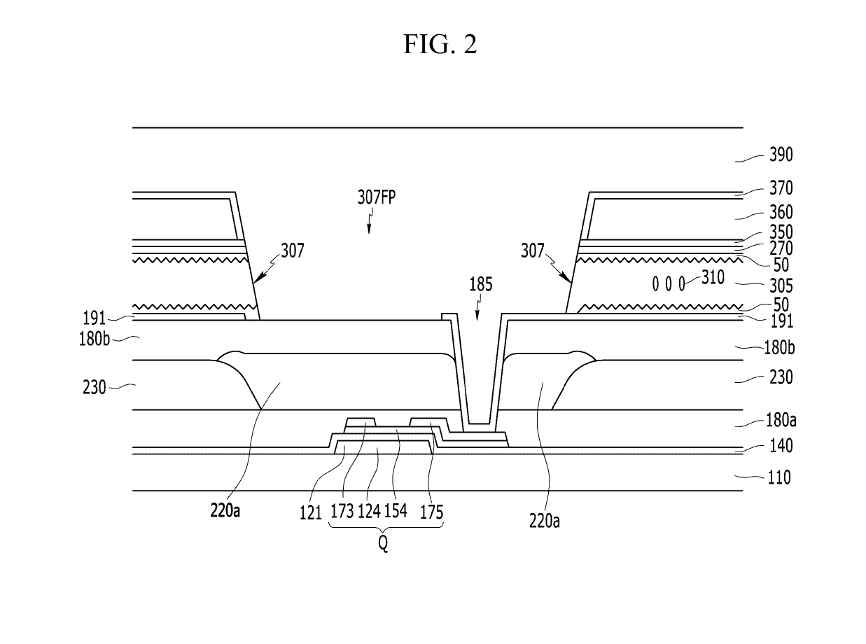

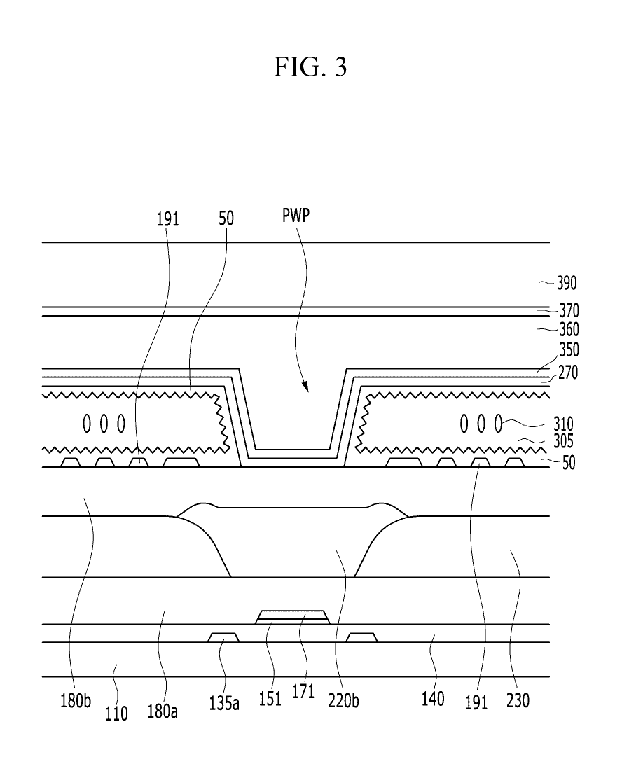

FIG. 1 is a top plan view of an exemplary embodiment of a display panel of a display unit. FIG. 2 is a cross-sectional view taken along line II-II of FIG. 1. FIG. 3 is a cross-sectional view taken along line of FIG. 1.

Referring to FIG. 1 to FIG. 3, in an exemplary embodiment of a display device a gate line 121 and a storage electrode line 131 are disposed on a substrate 110 made of transparent glass or plastic. The gate line 121 includes a gate electrode 124. The storage electrode line 131 mainly extends in a transverse direction, and transfers a predetermined voltage such as a common voltage (“Vcom”). The storage electrode line 131 includes a pair of longitudinal portions 135a substantially extending perpendicular to the gate line 121 and a transverse portion 135b connecting ends of a pair of longitudinal portions 135a. The storage electrodes 135a and 135b may have a structure enclosing a pixel electrode 191.

In another exemplary embodiment, a gate insulating layer 140 is disposed on the gate line 121 and the storage electrode line 131. A semiconductor 151 positioned below a data line 171, a semiconductor 154 positioned below the source/drain electrodes, and a channel portion of a thin film transistor are deposed on the gate insulating layer 140.

In still another exemplary embodiment, a plurality of ohmic contacts (not shown) may be disposed on each of the semiconductors 151 and 154 and between the data line 171 and source/drain electrodes.

In yet another exemplary embodiment, data conductors 171, 173, and 175, including the source electrode 173, the data line 171 connected to the source electrode 173, and the drain electrode 175, are disposed on each of the semiconductor layers 151 and 154 and the gate insulating layer 140. The gate electrode 124, the source electrode 173, and the drain electrode 175 form a thin film transistor Q together with the semiconductor layer 154, and a channel of the thin film transistor Q is formed in the semiconductor layer portion 154 between the source electrode 173 and the drain electrode 175.

In another exemplary embodiment, a first interlayer insulating layer 180a is disposed on the data conductors 171, 173, and 175, and the exposed portion of the semiconductor layer 154. In an aspect of the exemplary embodiment, the first interlayer insulating layer 180a may include an inorganic insulator such as silicon nitride (SiNx), silicon oxide (SiOx), or the like, or an organic insulator.

In another exemplary embodiment, a color filter 230 and light blocking members 220a and 220b are disposed on the first interlayer insulating layer 180a.

Each of the light blocking members 220a and 220b has a lattice structure having an opening corresponding to a region displaying an image, and each is formed from a material that reduces or substantially prevents the transmission of light. The color filter 230 is disposed on openings of the light blocking members 220a and 220b. The light blocking members 220a and 220b include a horizontal light blocking member 220a disposed in a direction parallel to the gate line 121, and a vertical light blocking member 220b disposed in a direction parallel to the data line 171. In another exemplary embodiment, the vertical light blocking member 220b may be omitted.

In an aspect of the exemplary embodiment, the color filter 230 may display at least one primary color, such as red, green or blue. In another aspect of the exemplary embodiment, the colors are not limited to red, green, and blue, and the color filter 230 may also display at least one color selected from a cyan-based color, a magenta-based color, a yellow-based color and a white-based color. In still another aspect of the exemplary embodiment, the color filter 230 may be formed from materials displaying different colors for each adjacent pixel.

In another exemplary embodiment, a second interlayer insulating layer 180b covering the color filter 230 and the light blocking members 220a and 220b is disposed on the color filter 230 and the light blocking members 220a and 220b. In an aspect of the exemplary embodiment, the second interlayer insulating layer 180b may include an inorganic insulating material, such as silicon nitride (SiNx) or silicon oxide (SiOx), or the like, or an organic insulating material. In another exemplary embodiment, unlike the cross-sectional view of FIG. 2 where a step is generated due to a difference in thickness between the color filter 230 and the light blocking members 220a and 220b, the second interlayer insulating layer 180b includes an organic insulating material, and thus it is possible to reduce or remove the step.

In an exemplary embodiment, the color filter 230, the light blocking members 220a and 220b and the interlayer insulating layers 180a and 180b have a contact hole 185 exposing the drain electrode 175.

In another exemplary embodiment, a pixel electrode 191 is disposed on the second interlayer insulating layer 180b.

In an exemplary embodiment, an overall shape of the pixel electrode 191 is a quadrangle and the pixel electrode 191 includes cross stems configured by a horizontal stem 191a and a vertical stem 191b crossing the horizontal stem 191a. Further, the pixel electrode 191 is divided into four sub-regions by the horizontal stem 191a and the vertical stem 191b, and each sub-region includes a plurality of minute branches 191c.

In an aspect of the exemplary embodiment, the pixel electrode 191 may further include an outer stem surrounding an outer circumference of the pixel electrode 191.

In an exemplary embodiment, the plurality of minute branches of two adjacent sub-regions may be perpendicular to each other. In another exemplary embodiment, a width of each minute branch may be gradually increased, or a distance between the minute branches 191c may be varied.

In an exemplary embodiment, the pixel electrode 191 includes an extension 197 which is connected at a lower end of the vertical stem 191b, has a larger area than the vertical stem 191b, and is electrically and physically connected to the drain electrode 175 through the contact hole 185 at the extension 197, thereby receiving the data voltage from the drain electrode 175.

The thin film transistor Q and the pixel electrode 191 described above are merely described as examples, and a structure of the thin film transistor and a design of the pixel electrode may be modified in order to improve side visibility or as otherwise desired.

In an exemplary embodiment, a plurality of protrusions 50 is formed on the surface of the pixel electrode 191. The plurality of protrusions 50 include an alignment polymer formed by irradiating an ultraviolet (“UV”) light onto a liquid crystal layer that includes a mixture of a reactive mesogen and a liquid crystal molecule 310. The plurality of protrusions 50 serve as a vertical alignment layer formed by coating a polyimide having a vertical alignment group that induces the vertical alignment of the liquid crystal molecule 310. A detailed material, structure and effect of the plurality of protrusions 50 will be described further below.

In another exemplary embodiment, the plurality of protrusions 50 is formed under the common electrode 270 facing the pixel electrode 191, and a microcavity 305 is formed between the plurality of protrusions 50 formed to face each other.

Referring to FIG. 3, in an exemplary embodiment, a plurality of protrusions 50 is formed on a sidewall of microcavity 305 and may be connected to each other in the microcavity 305.

In an exemplary embodiment, a liquid crystal material including the liquid crystal molecule 310 is injected in the microcavity 305, and the microcavity 305 has an inlet portion 307. The microcavity 305 may be formed according to a column direction of the pixel electrode 191, i.e., the vertical direction. In an aspect of the exemplary embodiment, the reactive mesogen forming the protrusion 50 and the liquid crystal material including the liquid crystal molecule 310 may be injected in the microcavity 305 by using a capillary force.

In an exemplary embodiment, the microcavity 305 is divided in a vertical direction by a plurality of trenches 307FP positioned at a portion overlapping the gate line 121, and a plurality of microcavities 305 may be formed along the direction in which the gate line 121 is extended. Each of the plurality of formed microcavities 305 may correspond to a pixel area, and the pixel areas may correspond to a region displaying an image.

In an exemplary embodiment, the common electrode 270 and the lower insulating layer 350 are disposed on the plurality of protrusions 50 formed at a position facing the pixel electrode. The common electrode 270 receives the common voltage and generates an electric field together with the pixel electrode 191 to which the data voltage is applied in order to determine a direction in which the liquid crystal molecules 310 positioned at the microcavity 305 between the two electrodes are inclined. The common electrode 270 forms a capacitor with the pixel electrode 191 to maintain the received voltage even after the thin film transistor is turned off. In an aspect of the exemplary embodiment, the lower insulating layer 350 may be formed from a material such as silicon nitride (SiNx), silicon oxide (SiOx) or the like.

In the present exemplary embodiment, it is described that the common electrode 270 is formed on the microcavity 305. In another exemplary embodiment, the common electrode 270 is formed under the microcavity 305, so that liquid crystal driving according to a coplanar electrode (“CE”) mode is possible.

In another exemplary embodiment, a roof layer 360 is disposed on the lower insulating layer 350. The roof layer 360 serves to make a support so as to form the microcavity 305, which is a space between the pixel electrode 191 and the common electrode 270. In an aspect of the exemplary embodiment, the roof layer 360 may include a photoresist or other organic materials.

In an exemplary embodiment, an upper insulating layer 370 is disposed on the roof layer 360. In another exemplary embodiment, the upper insulating layer 370 may contact the roof layer 360. In still another exemplary embodiment, the upper insulating layer 370 may be brought into contact with an upper surface of the roof layer 360.

In an exemplary embodiment, a capping layer 390 is disposed on the upper insulating layer 370. The capping layer 390 covers the inlet portion 307 of the microcavity 305 exposed by the trench 307FP while filling the trench 307FP. In an aspect of the exemplary embodiment, the capping layer 390 includes an organic material or an inorganic material.

In an embodiment, a partition wall portion (“PWP”) is formed between the plurality of microcavities 305 adjacent to each other in the horizontal direction, as shown in FIG. 3. In an aspect of the exemplary embodiment, the PWP may be formed along the direction that the data line 171 extends and may be covered by the roof layer 360. In another aspect of the exemplary embodiment, the PWP is filled with the lower insulating layer 350, the common electrode 270, the upper insulating layer 370, and roof layer 360 and the structure may form a partition wall to partition or define the microcavity 305. In yet another aspect of the exemplary embodiment, the PWP structure is formed between the plurality of microcavities 305, and therefore less stress is generated even through the substrate 110 is bent, and the degree of modification of a cell gap may be significantly reduced.

In another exemplary embodiment, although not illustrated, the upper and lower surface of the display panel may further be formed as a polarizer. In an aspect of the exemplary embodiment, the polarizer may be formed of a first polarizer and a second polarizer. The first polarizer may be attached to a lower surface of the substrate 110 and the second polarizer may be attached on the capping layer 390.

Next, the plurality of protrusions 50 formed inside the microcavity of the present exemplary embodiment will be described in detail. In a liquid crystal display having a conventional microcavity, to obtain a vertical alignment layer, an alignment material having a vertical alignment group in a side chain is coated and sintered to manufacture the alignment layer. However, since the process of coating the alignment layer in the microcavity is not easy, an alignment layer with low viscosity must be used. Accordingly, the thickness of the alignment layer is formed to be less than 10 nm, however this results in a problem of the vertical alignment force being decreased. Also, there is a problem in that it is difficult for the alignment layer in the micro cavity to be uniformly coated.

However, in an exemplary embodiment of the liquid crystal display, instead of forming a conventional alignment layer, ultraviolet (“UV”) light is irradiated onto the mixture of the reactive mesogen mixed and the liquid crystal molecule to form the protrusion, and the liquid crystal molecule may be aligned by using the protrusion. Accordingly, the above-described problem is solved. That is, instead of coating and sintering the alignment material, the protrusion is formed inside the microcavity by polymerizing the reactive mesogen, and the vertical alignment force of the liquid crystal is induced by using the protrusion.

In an aspect of the exemplary embodiment, the protrusion may be formed by a method of injecting the mixture of the reactive mesogen and the liquid crystal molecule into at least one or the plurality of micro cavities and irradiating UV light thereon to polymerize the reactive mesogen. In an exemplary embodiment, the reactive mesogen may include at least one the compound represented by Chemical Formulas 1-1 to 1-14:

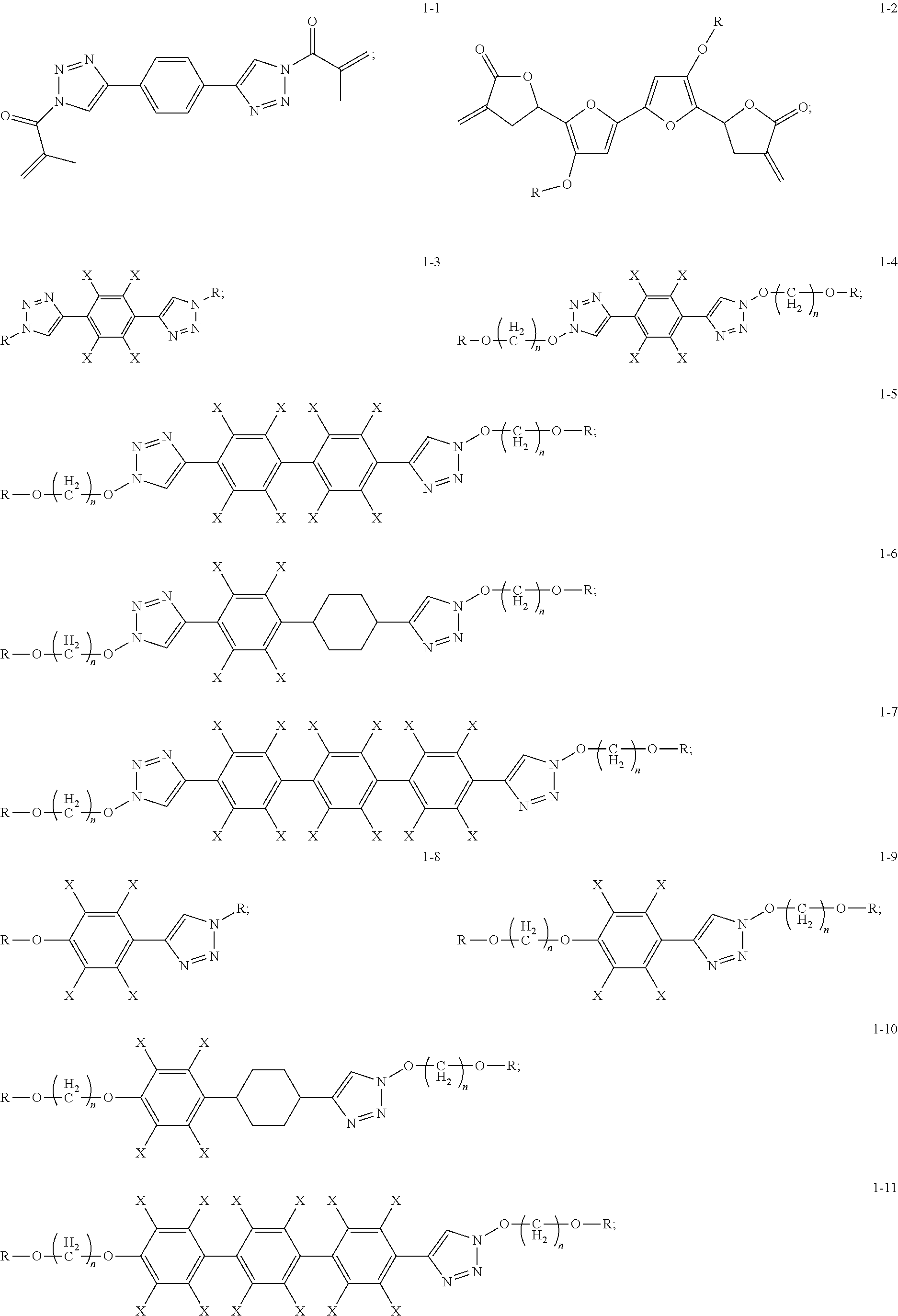

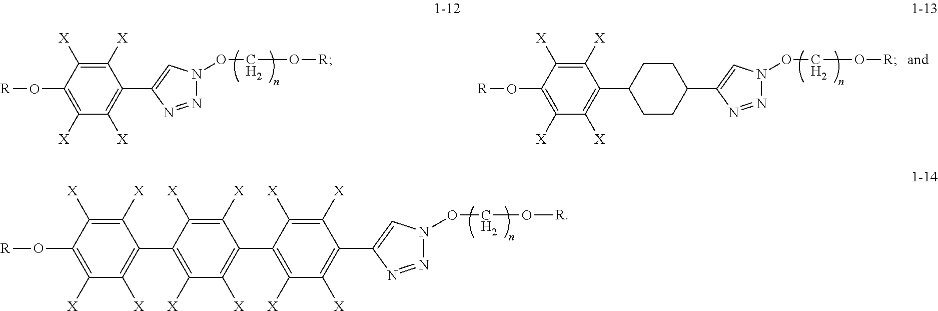

In an aspect of the exemplary embodiment, in Chemical Formulas 1-1 to 1-14, n is 1 to 20, and X may be at least one of hydrogen (H), a methyl (CH₃) group, an ethylbenzene (CH₂ₙCH₃) group, fluorine (F), bromine (Br), iodine (I), a hydroxide (OH) group, an isopropyl (C₃H₇) group, an amine (NH₂) group, and a cyano (CN) group. In another aspect of the exemplary embodiment, R may be at least one of

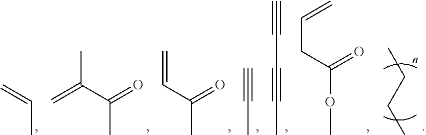

In

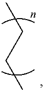

n may be between 1 to 20.

In another exemplary embodiment, the reactive mesogen may be at least one compound represented by Chemical Formulas 2-1 to 2-17:

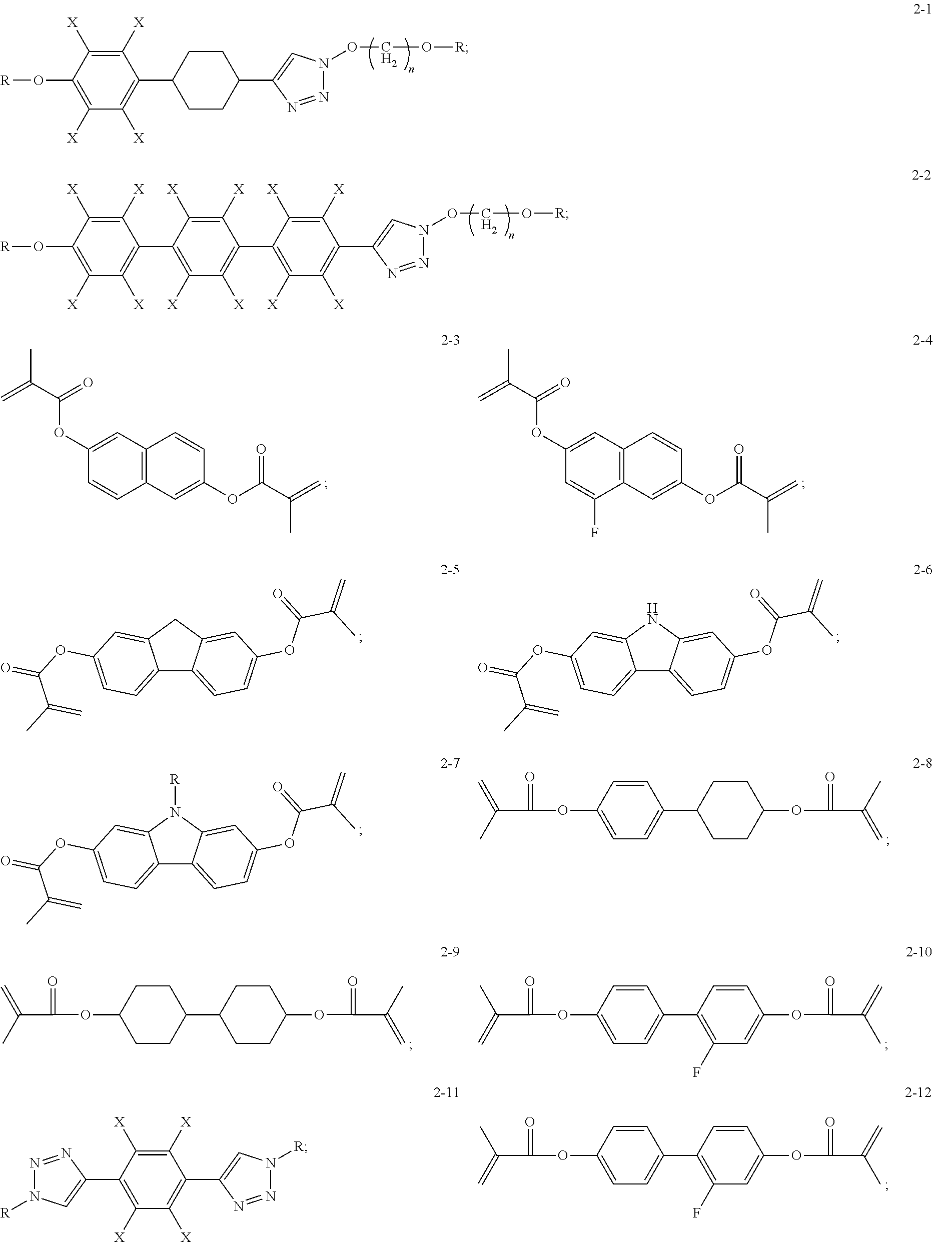

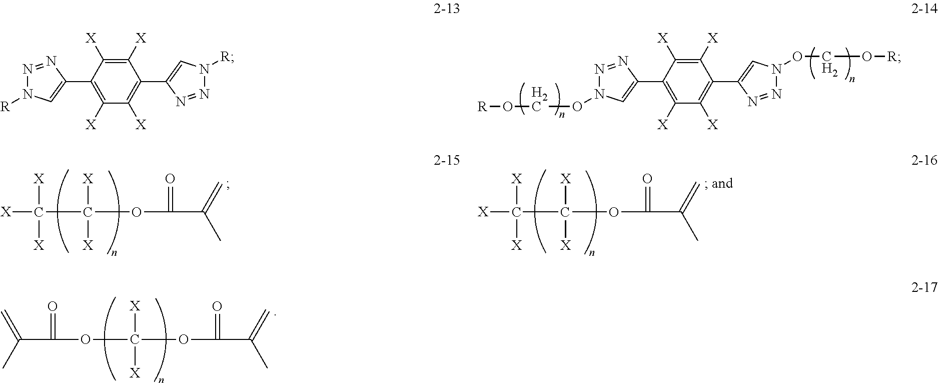

In casein aspect of the exemplary embodiment, in Chemical Formulas 2-1 to 2-17, n is 1 to 20, and X may be at least one of hydrogen (H), fluorine (F), chlorine (CO, bromine (Br), iodine (I), an amine (NH₂) group and a hydroxide (OH) group.

In another aspect of the exemplary embodiment, R may be at least one selected of

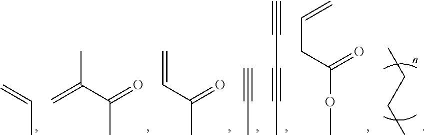

In

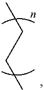

n may be between 1 to 20.

As described above, in an exemplary embodiment of the liquid crystal display, the alignment layer is not formed inside the microcavity, but the protrusion is formed and the vertical alignment of the liquid crystal molecule is induced by the protrusion. Accordingly, the existing problem with the process that it is difficult to coat the alignment layer inside the micro cavity and the problem that the vertical alignment force is insufficiently obtained due to the application of the alignment layer with low viscosity are solved. Also, the coating process and the sintering process of the alignment layer may be omitted such that the process may be reduced and the material cost may be reduced.

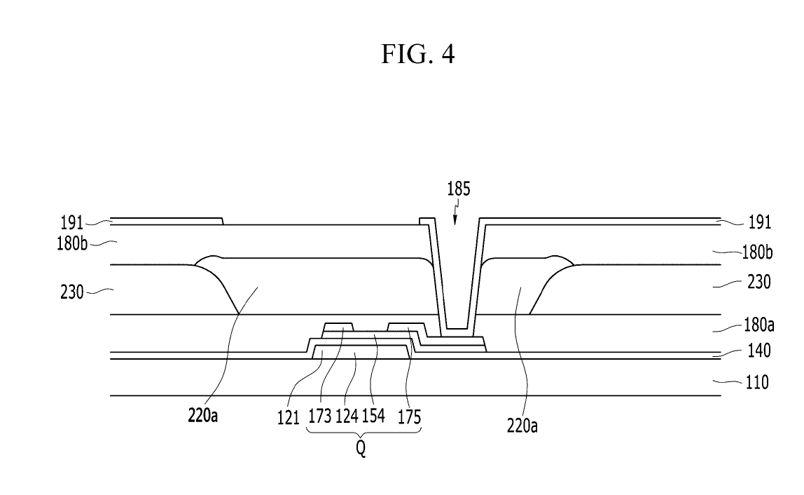

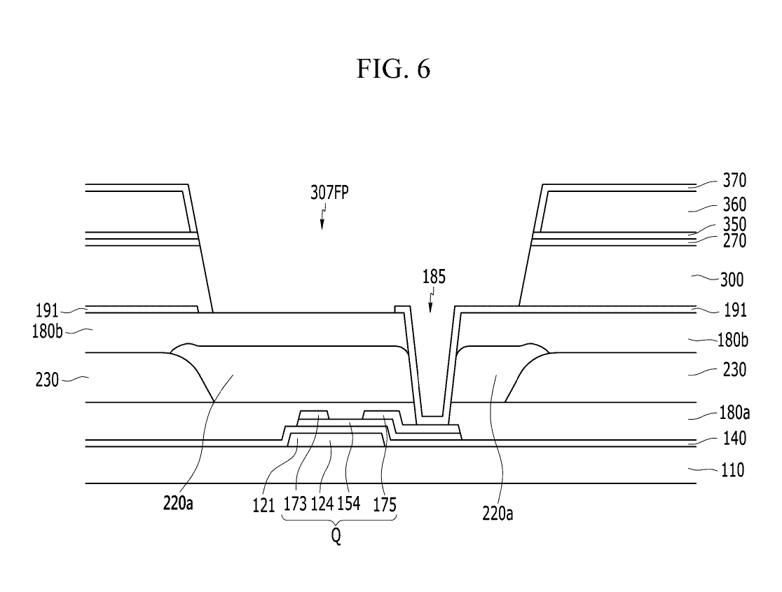

Next, an exemplary embodiment of a manufacturing method of the liquid crystal display will be described. FIGS. 4 to FIG. 9 are process cross-sectional views of an exemplary embodiment of a liquid crystal display.

Referring to FIG. 1 and FIG. 4, in an exemplary embodiment, to form a switching element that on a substrate 110, a gate line 121 extending in the horizontal direction, a gate insulating layer 140 on the gate line 121, semiconductor layers 151 and 154 on the gate insulating layer 140, and a source electrode 173 and a drain electrode 175 are formed. In an aspect of the exemplary embodiment, a data line 171 connected to the source electrode 173 may be formed to extend in a vertical direction while intersecting the gate line 121.

In another exemplary embodiment, the first interlayer insulating layer 180a is formed on the data conductor including the source electrode 173, the drain electrode 175, and the data line 171, and on the exposed semiconductor layer 154.

In still another exemplary embodiment, a color filter 230 is formed on the first interlayer insulating layer 180a at a position corresponding to the pixel area, and a light blocking member 220 is formed between the color filters 230.

In yet another exemplary embodiment, The second interlayer insulating layer 180b is formed on the color filter 230 and the light blocking member 220 while covering the color filter 230 and the light blocking member 220, and the second interlayer insulating layer 180b has a contact hole 185 to electrically and physically connect the pixel electrode 191 and the drain electrode 175.

Next, in another exemplary embodiment, the pixel electrode 191 is formed on the second interlayer insulating layer 180b.

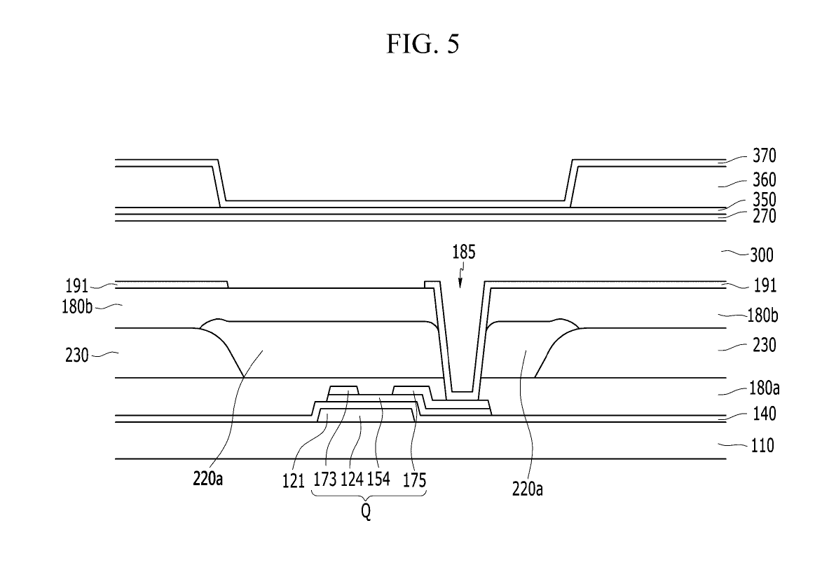

Referring to FIG. 5, in another exemplary embodiment, a sacrificial layer 300 is formed on the pixel electrode 191. Next, a common electrode 270, a lower insulating layer 350 and a roof layer 360 are sequentially formed on the sacrificial layer 300. In an aspect of the exemplary embodiment, the roof layer 360 may be removed at a region corresponding to the horizontal light blocking member 220a positioned between the pixel areas adjacent in the vertical direction by an exposure and development process. Next, in another exemplary embodiment, an upper insulating layer 370 covering the roof layer 360 and the exposed lower insulating layer 350 is formed.

Referring to FIG. 16, in an exemplary embodiment, the upper insulating layer 370, the lower insulating layer 350 and the common electrode 270 are dry-etched to partially remove the upper insulating layer 370, the lower insulating layer 350 and the common electrode 270, thereby forming the trench 307FP. In an exemplary embodiment, the upper insulating layer 370 may have a structure covering the side of the roof layer 360, but the structure is not limited thereto, and the upper insulating layer 370 covering the side of the roof layer 360 may be removed to expose the side of the roof layer 360 to the outside.

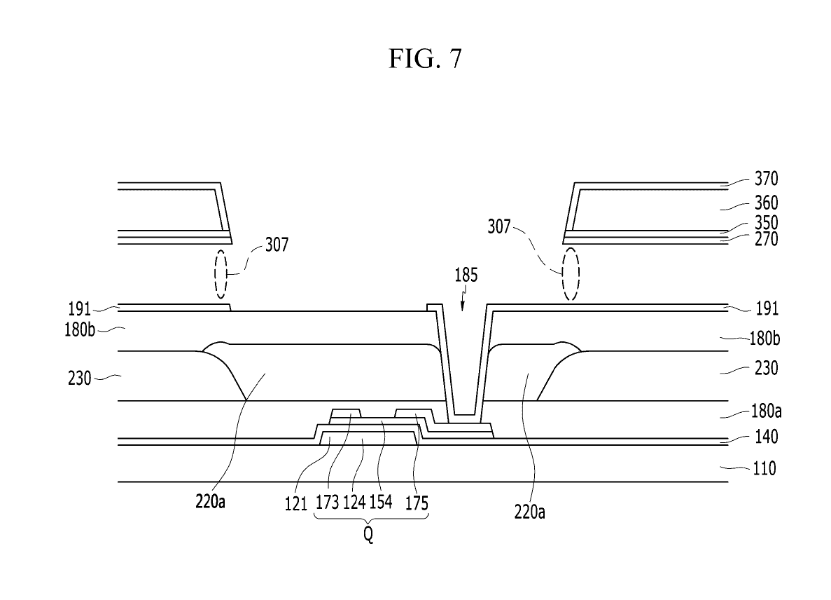

Referring to FIG. 7, in another exemplary embodiment, the sacrificial layer 300 is removed by an oxygen (O₂) ashing process or a wet-etching method through the trench 307FP. In an aspect of the exemplary embodiment, the microcavity 305 having the inlet portion 307 is formed. The microcavity 305 is an empty space formed when the sacrificial layer 300 is removed.

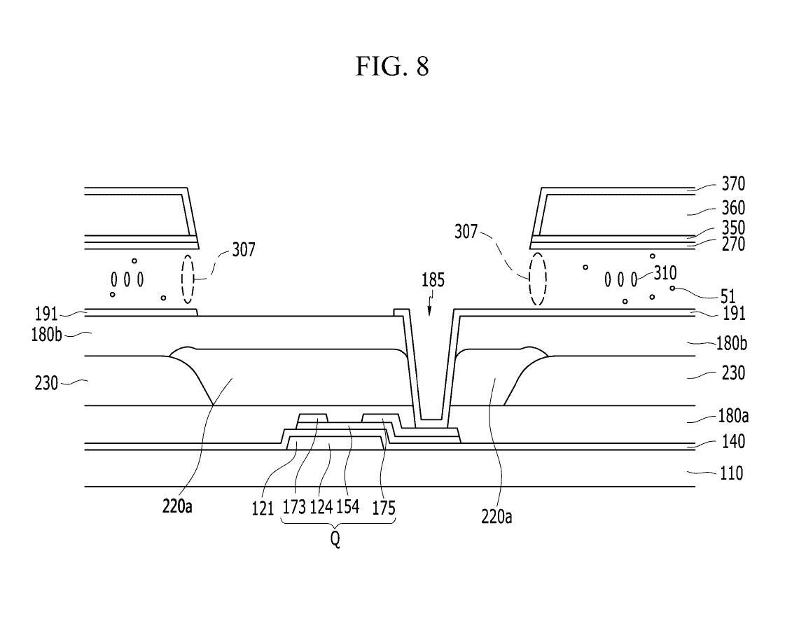

Next, referring FIG. 8, in an exemplary embodiment, the liquid crystal material in which the liquid crystal molecule 310 and the reactive mesogen 51 are mixed is injected through the inlet portion 307. In an exemplary embodiment, a content of the reactive mesogen 51 may be included at a concentration of 2,000 parts per million (ppm) to 10,000 ppm, based on the entire liquid crystal mixture, including the solvent used therein.

In an exemplary embodiment, the reactive mesogen may be at least one compound represented by Chemical Formulas 1-1 to 1-14:

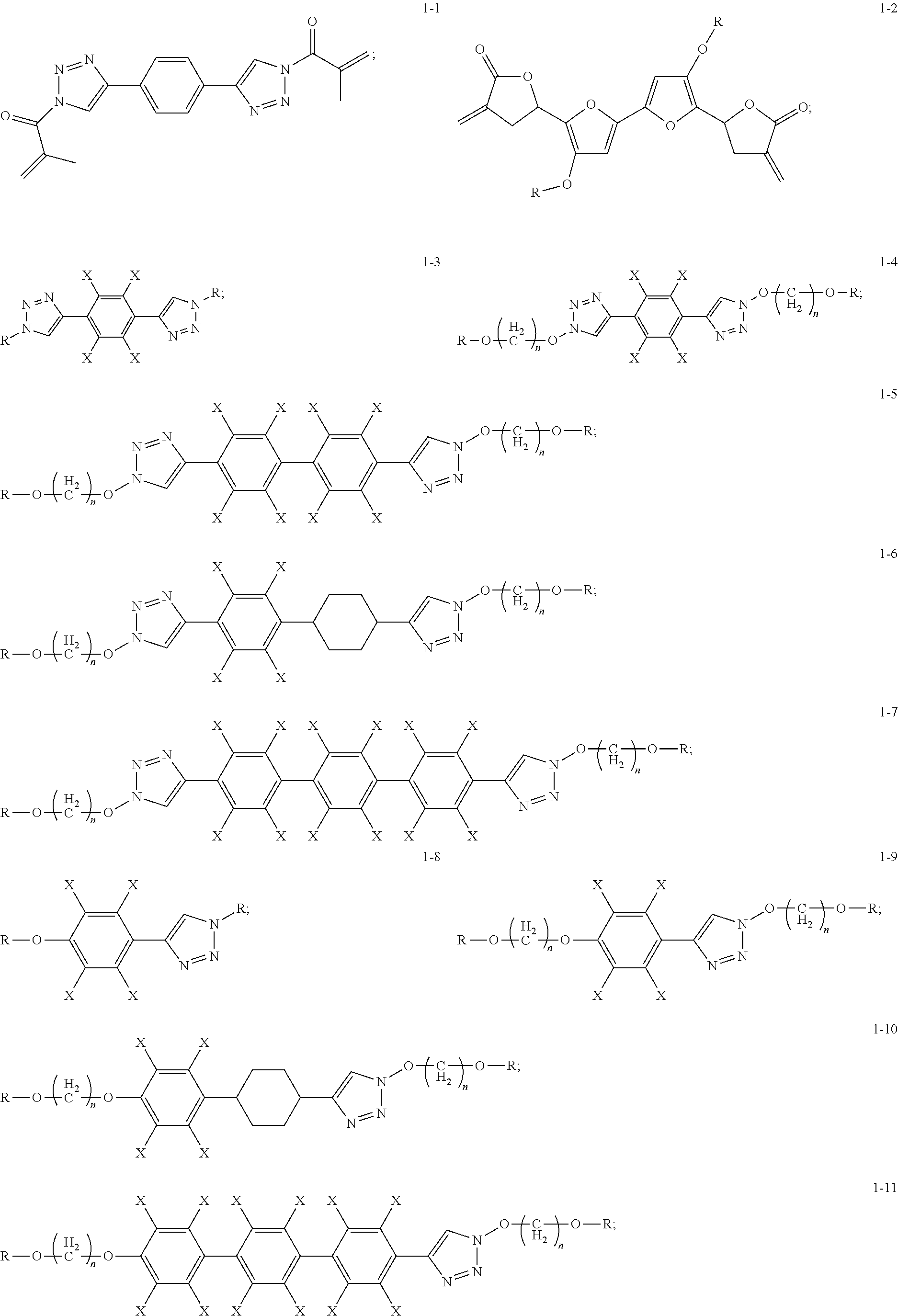

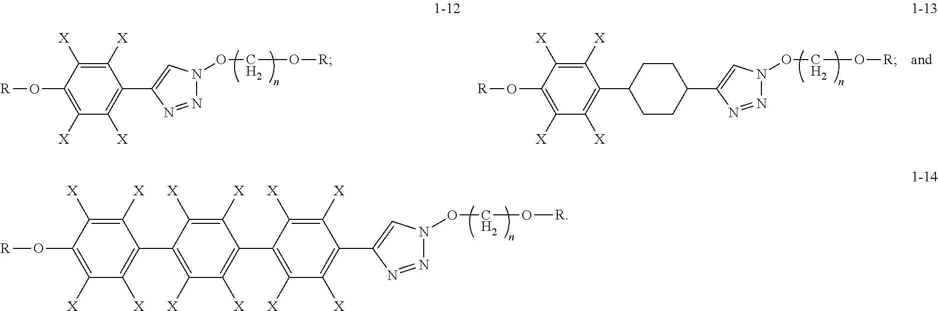

In an aspect of the exemplary embodiment, in Chemical Formulas 1-1 to 1-14, n is 1 to 20, and X may be at least one of hydrogen (H), a methyl (CH₃) group, an ethylbenzene (CH₂ₙCH₃) group, fluorine (F), bromine (Br), iodine (I), a hydroxide (OH) group, an isopropyl (C₃H₇) group, an amine (NH₂) group and a cyano (CN) group.

In another aspect of the exemplary embodiment, in Chemical Formulas 1-1 to 1-14, R may be at least one of

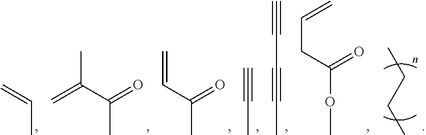

In

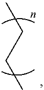

n may be 1 to 20.

In another exemplary embodiment, in Chemical Formulas 1-1 to 1-14, the reactive mesogen may be at least one compound represented by Chemical Formulas 2-1 to 2-17:

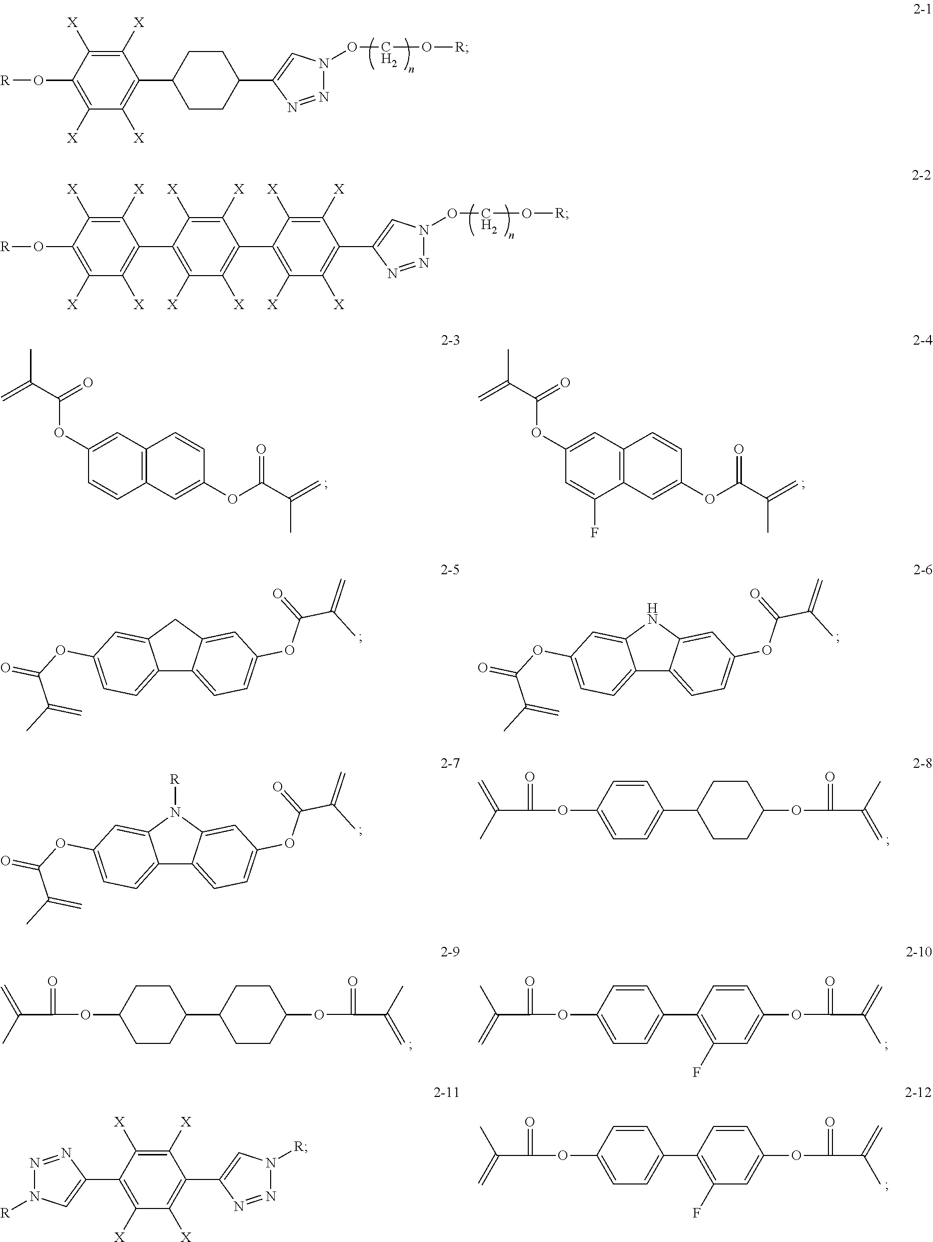

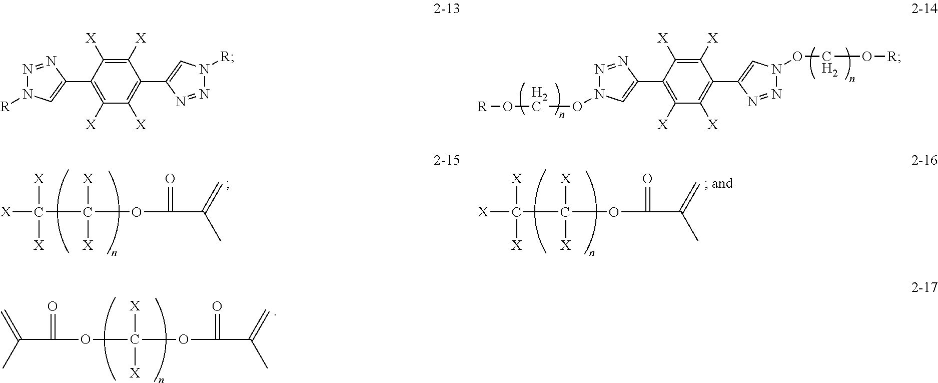

In an aspect of the exemplary embodiment, in Chemical Formulas 2-1 to 2-17, n is 1 to 20, and X may be at least one of hydrogen (H), fluorine (F), chlorine (Cl), bromine (Br), iodine (I), an amine (NH₂) group and a hydroxide (OH) group.

In another aspect of the exemplary embodiment, R may be at least one of

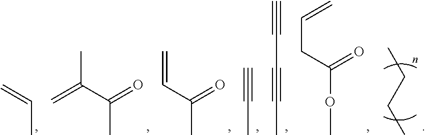

In

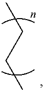

n may be between 1 to 20.

In an aspect of the exemplary embodiment, the alignment layer is not formed on the pixel electrode 191 and the liquid crystal material in which the liquid crystal molecule 310 and the reactive mesogen 51 are mixed is injected in the state in which the surface of the pixel electrode 191 is exposed.

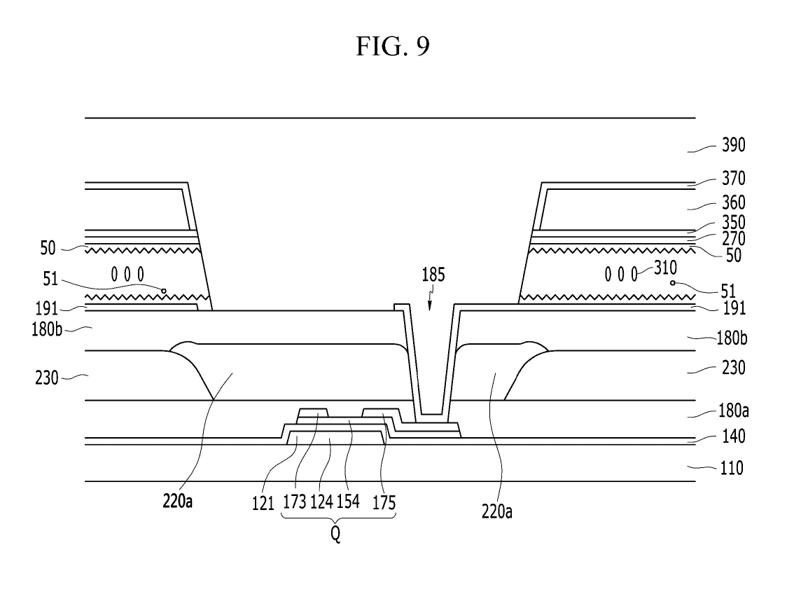

Next, in an exemplary embodiment, as shown in FIG. 9, a capping layer 390 covering the inlet portion 307 and the trench is formed on the upper insulating layer 370.

Next, in another exemplary embodiment, the ultraviolet (“UV”) light is irradiated to polymerize the reactive mesogen, the reactive mesogen 51 is polymerized and divided from the mixture solvent of the liquid crystal molecule 310 and the reactive mesogen 51 to form the protrusion in the region adjacent to the pixel electrode 191 and the common electrode 270, and the display device of the structure shown in FIG. 2 is finally completed.

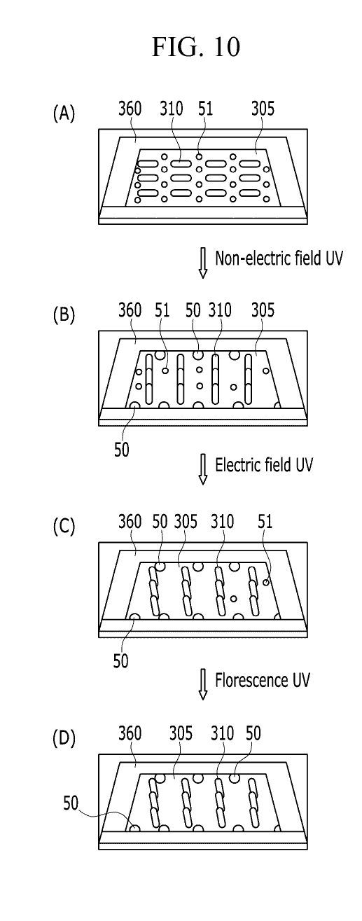

The process of forming the protrusion by irradiating the mixture of the reactive mesogen and the liquid crystal molecule via UV irradiation will be described in detail with reference to FIG. 10.

FIG. 10 is a view showing an exemplary embodiment of a process for forming a protrusion by using an UV light.

FIG. 10(A) is an exemplary embodiment of a display device in which the liquid crystal molecule and the reactive mesogen are mixed and injected into the microcavity. FIG. 10(A) illustrates a horizontal alignment state in which the liquid crystal and the reactive mesogen are mixed and exist.

In an exemplary embodiment, as shown in FIG. 10(B), the reactive mesogen is divided and polymerized from the liquid crystal molecule through a non-electric field UV process to form the protrusion. In an aspect of the exemplary embodiment, the liquid crystal molecule is vertically aligned through the formation of the protrusion.

In another aspect of the exemplary embodiment, not all of the reactive mesogen included in the liquid crystal mixture solvent is reacted, and a portion thereof exists in a non-reacted state.

Next, as shown in FIG. 10(C), in another exemplary embodiment, if the UV is irradiated in the state of the electric field, a pretilt angle between about 88.6 degrees to about 90.0 degrees is formed while the non-reacted reactive mesogen is reacted.

Next, as shown in FIG. 10(D), in yet another exemplary embodiment, the non-reacted reactive mesogen is removed through a UV fluorescence process. The remaining reactive mesogen in the liquid crystal is removed by the UV fluorescence process, and the remaining reactive mesogen in the liquid crystal layer is finally maintained at less than about 150 parts per million (ppm).

That is, in exemplary embodiments of the display device and the manufacturing method thereof, as described above, the mixture solvent of the liquid crystal and the reactive mesogen is injected into the microcavity and the protrusion is formed through UV irradiation instead of the conventional alignment layer formation process.

Accordingly, the conventional problem associated with the process that it is difficult to coat the alignment layer inside of the microcavity and the problem that the vertical alignment force is insufficiently obtained due to the application of the alignment layer with low viscosity are solved. Also, the coating process and the sintering process of the alignment layer may be omitted such that the process may be reduced and the material costs may be reduced.

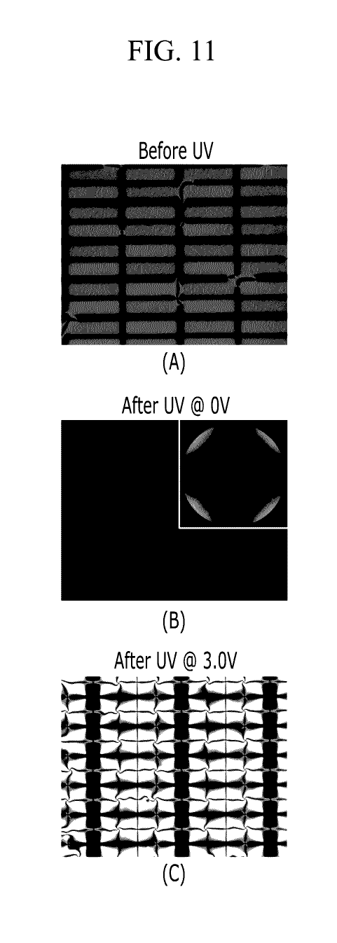

FIG. 11 shows an image of an exemplary embodiment of a display device. In in an aspect of the exemplary embodiment, the reactive mesogen used to form the protrusion is as follows:

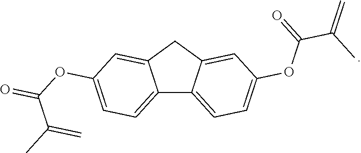 [SMILES: C=C(C)C(=O)Oc1ccc2c(c1)Cc1cc(OC(=O)C(=C)C)ccc1-2]

FIG. 11(A), showing the state of an exemplary embodiment of the display device before UV light is applied subsequent to the injection of the mixture solvent of the liquid crystal and the reactive mesogen, corresponds to FIG. 10(A). In this state, the liquid crystal of the display device is aligned in a horizontal state and does not represent black or white.

FIG. 11(B), shows an image of an exemplary embodiment of the display device after forming the protrusion by irradiating UV light onto the liquid crystal display injected with the mixture solvent of the liquid crystal and the reactive mesogen, corresponds to FIG. 10(B). The liquid crystal is vertically aligned by the formation of the protrusion, thereby representing black in the state in which the electric field is supplied.

Next, FIG. 11(C) shows an exemplary embodiment of the image driven by actually supplying the voltage to the display device. As shown in FIG. 11(C), it may be confirmed that the display device is normally driven even though the protrusion is formed without the alignment layer.

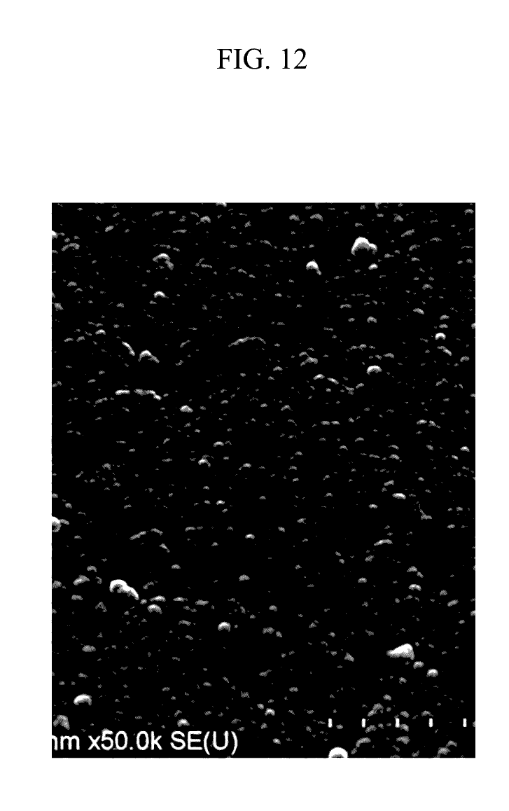

FIG. 12 is a surface image of an exemplary embodiment of a display device utilizing a protrusion, and produced without an alignment layer. As shown in FIG. 12, the vertical alignment force is applied to the liquid crystal layer by the formed protrusion.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a substrate;
a thin film transistor disposed on the substrate;
a pixel electrode disposed on the thin film transistor;
a roof layer facing the pixel electrode; and
a liquid crystal layer, having a plurality of microcavities, disposed between the pixel electrode and the roof layer, the liquid crystal layer comprising a liquid crystal molecule and a reactive mesogen,
wherein the liquid crystal molecule has a pretilt angle due to a protrusion disposed in a region of the plurality of microcavities adjacent to the pixel electrode.

2. The liquid crystal display of claim 1, wherein the protrusion comprises an alignment polymer produced by polymerizing the reactive mesogen included in the liquid crystal layer.

3. The liquid crystal display of claim 2, further comprising a common electrode disposed between the at least one microcavity in the plurality of microcavities and the roof layer, wherein the protrusion is positioned at an upper surface of the pixel electrode and a lower surface of the common electrode facing each other inside the microcavity.

4. The liquid crystal display of claim 3, further comprising a lower insulating layer disposed between the common electrode and the roof layer.

5. The liquid crystal display of claim 1, wherein the protrusion comprises a polymer produced by polymerizing at least one compound represented by Chemical Formulas 1-1 to 1-14 via ultraviolet irradiation: 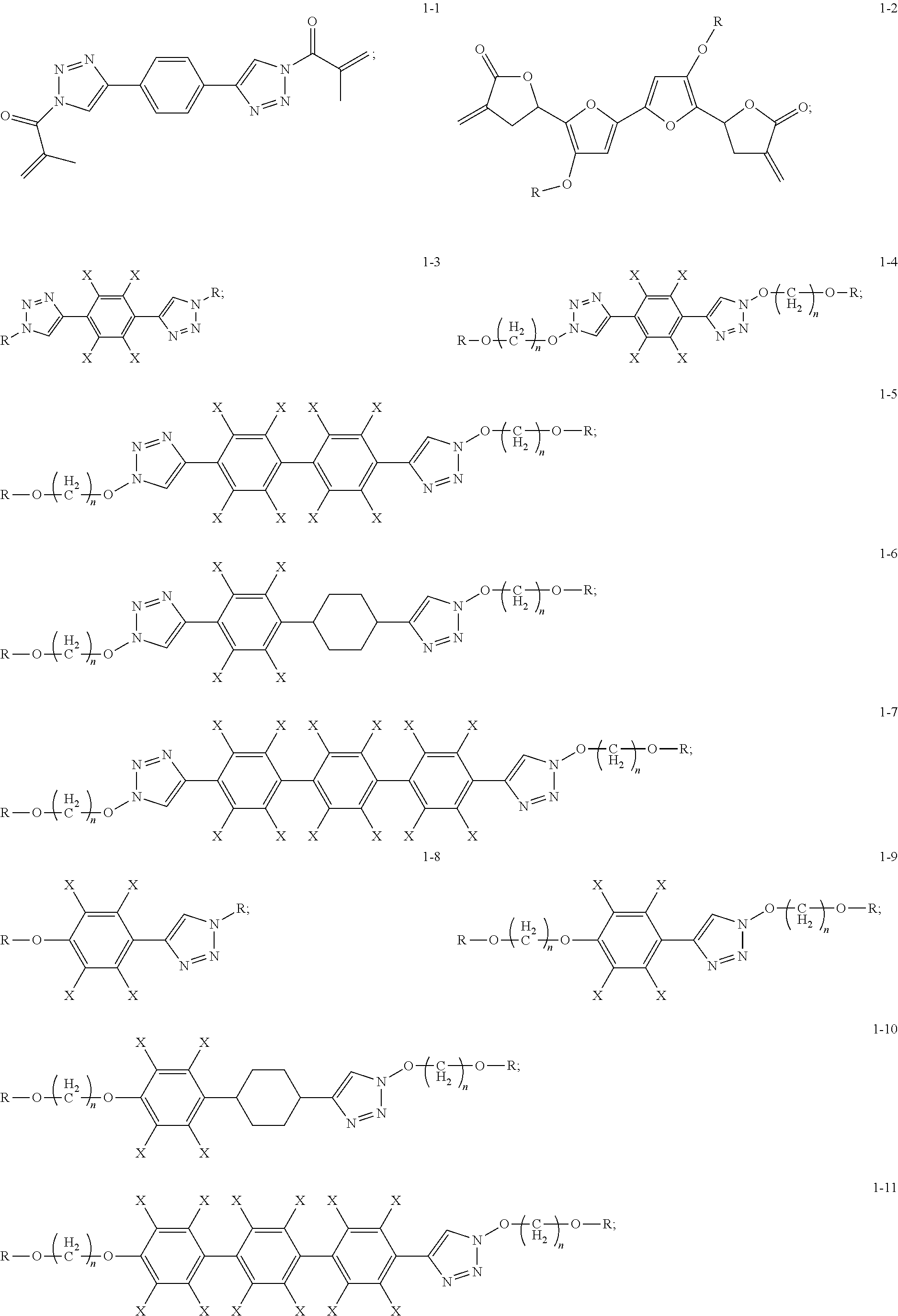 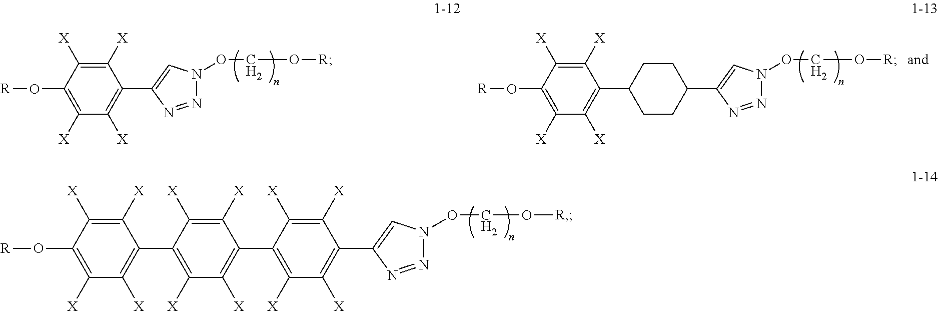
wherein, in Chemical Formulas 1-1 to 1-14,
n is 1 to 20,
X is at least one functional group selected from hydrogen, a methyl group, an ethylbenzene group, fluorine, bromine, iodine, a hydroxide group, an isopropyl group, an amine group and a cyano group, and
R is at least one compound selected from

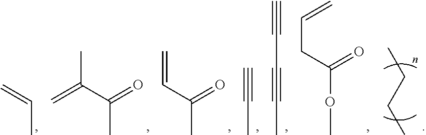

6. The liquid crystal display of claim 1, wherein the protrusion comprises a polymer produced by polymerizing at least one compound represented by Chemical Formulas 2-1 to 2-17 via ultraviolet irradiation: 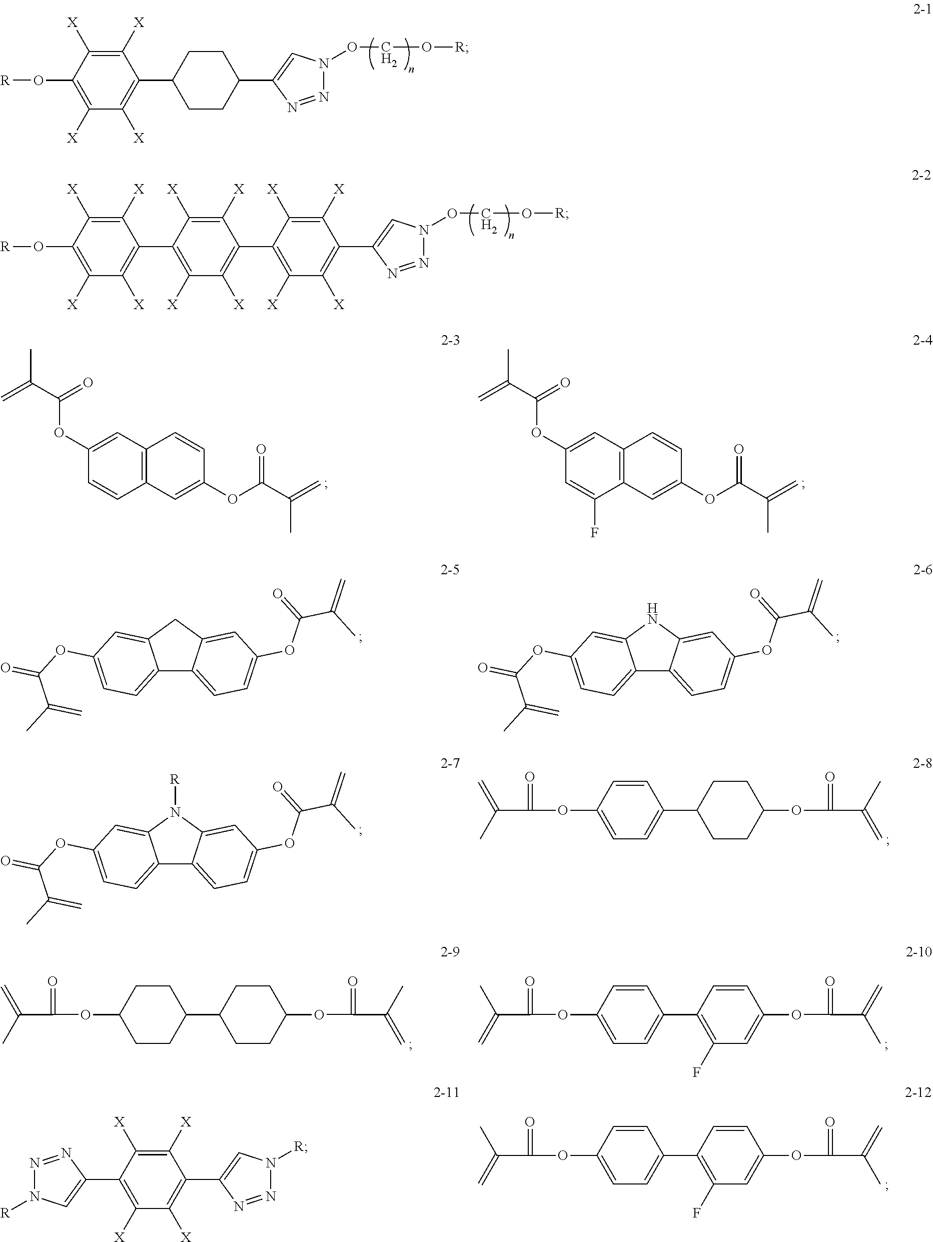 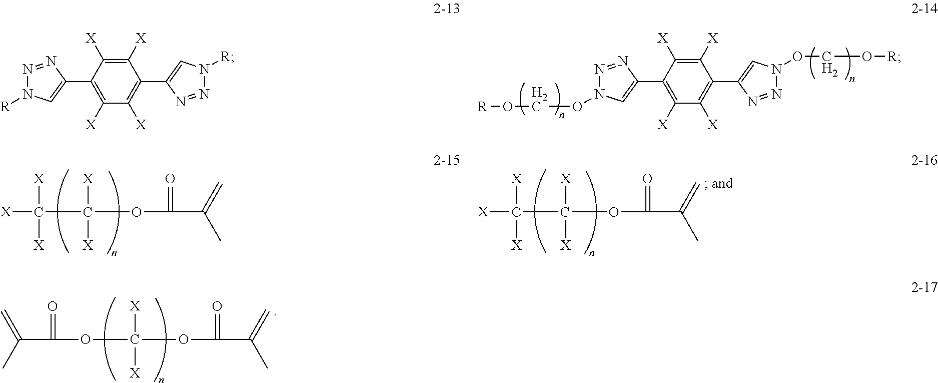
wherein, in Chemical Formulas 2-1 to 2-17,
n is 1 to 20,
X is at least one functional group selected from hydrogen, fluorine, chlorine, bromine, iodine, an amine group and a hydroxide group, and
R is at least one compound selected from

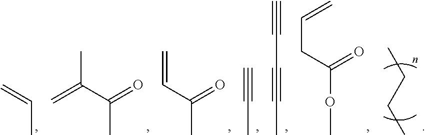

7. The liquid crystal display of claim 1, wherein a content of the reactive mesogen in the liquid crystal layer is less than 150 parts per million.

8. The liquid crystal display of claim 1, wherein the alignment layer does not exist in the plurality of microcavities.

9. The liquid crystal display of claim 1, wherein the liquid crystal layer is pretilted at an angle of about 1 degree to about 2 degrees.

10. The liquid crystal display of claim 1, further comprising a capping layer disposed on the roof layer, a trench disposed in the plurality of microcavities and the capping layer covers the trench.

11. The liquid crystal display of claim 1, wherein the protrusion is formed directly on a surface of the pixel electrode.

12. A method for manufacturing a liquid crystal display comprising:
forming a thin film transistor on a substrate;
connecting a pixel electrode to the thin film transistor;
forming a sacrificial layer on the pixel electrode;
forming a roof layer on the sacrificial layer;
removing the sacrificial layer to form a plurality of microcavities;
injecting a mixture of a liquid crystal molecule and a reactive mesogen into the plurality of microcavities; and
irradiating ultraviolet rays onto the mixture of the liquid crystal molecule and the reactive mesogen to form a protrusion in a region of the plurality of microcavities adjacent to the pixel electrode,
wherein the injection of the mixture of the liquid crystal molecule and the reactive mesogen is performed in a state in which the surface of the pixel electrode facing the plurality of microcavities is exposed.

13. The method of claim 12, wherein the content of the reactive mesogen in the mixture of the liquid crystal and the reactive mesogen is between about 2,000 parts per million to about 10,000 parts per million.

14. The method of claim 12, wherein the reactive mesogen comprises at least one compound represented by Chemical Formulas 1-1 to 1-14: 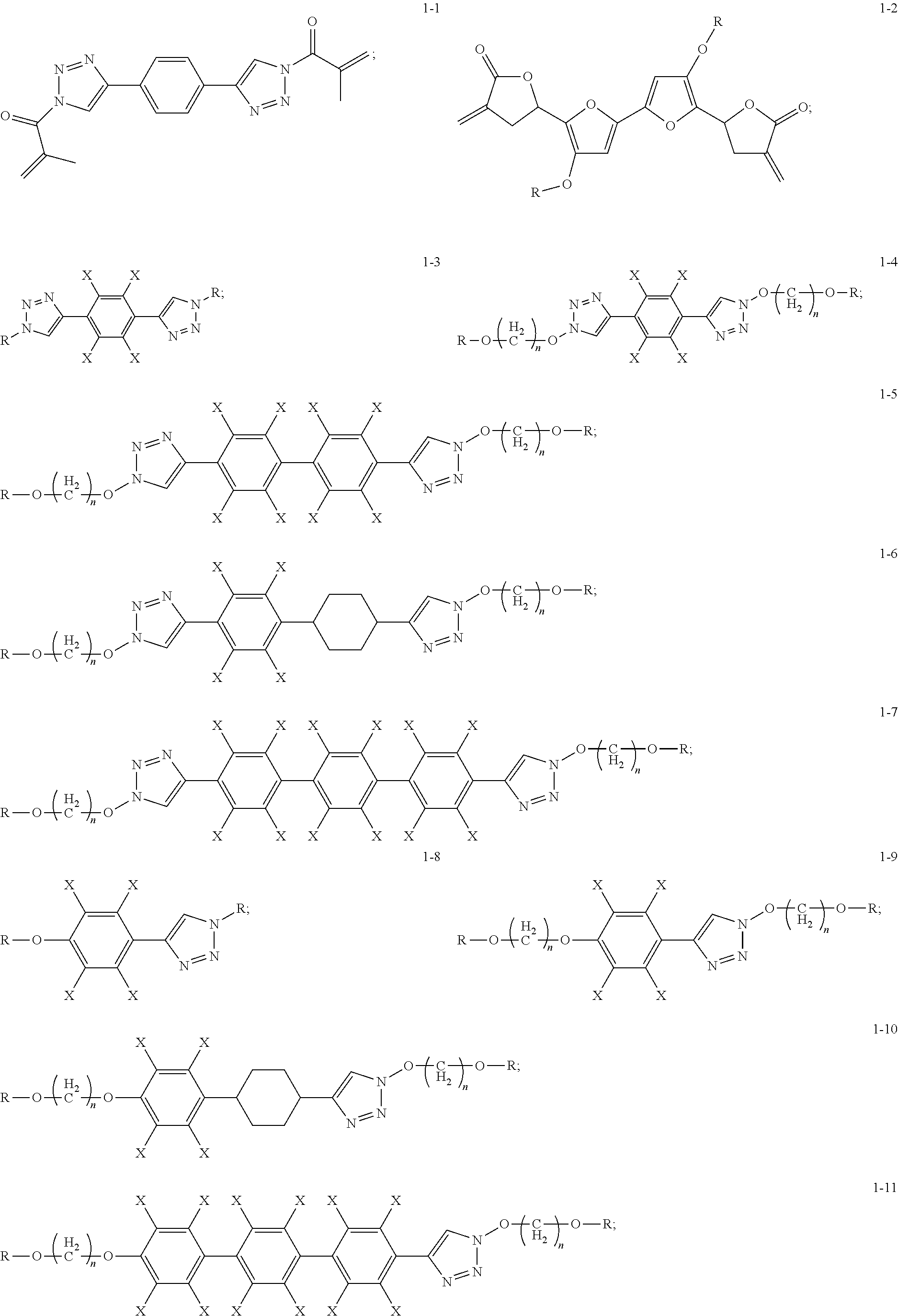 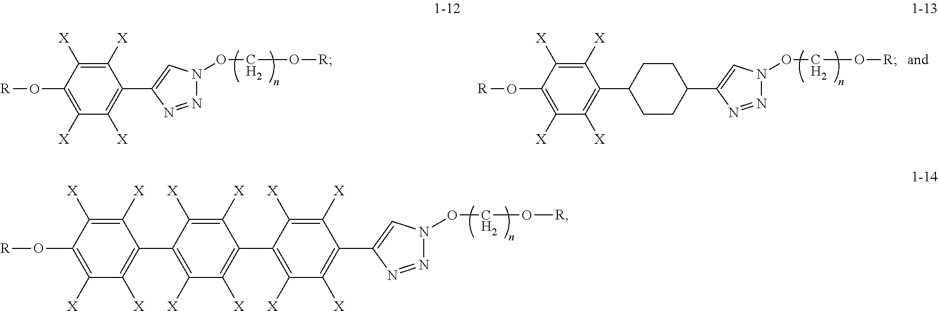
wherein, in Chemical Formulas 1-1 to 1-14,
n is 1 to 20,
X is at least one functional group selected from hydrogen, a methyl group, an ethylbenzene group, fluorine, bromine, iodine, a hydroxide group, an isopropyl group, an amine group and a cyano group, and
R is at least one compound selected from

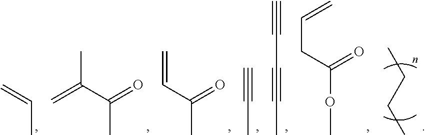

15. The method of claim 12, wherein the reactive mesogen comprises at least one compound represented by Chemical Formulas 2-1 to 2-17: 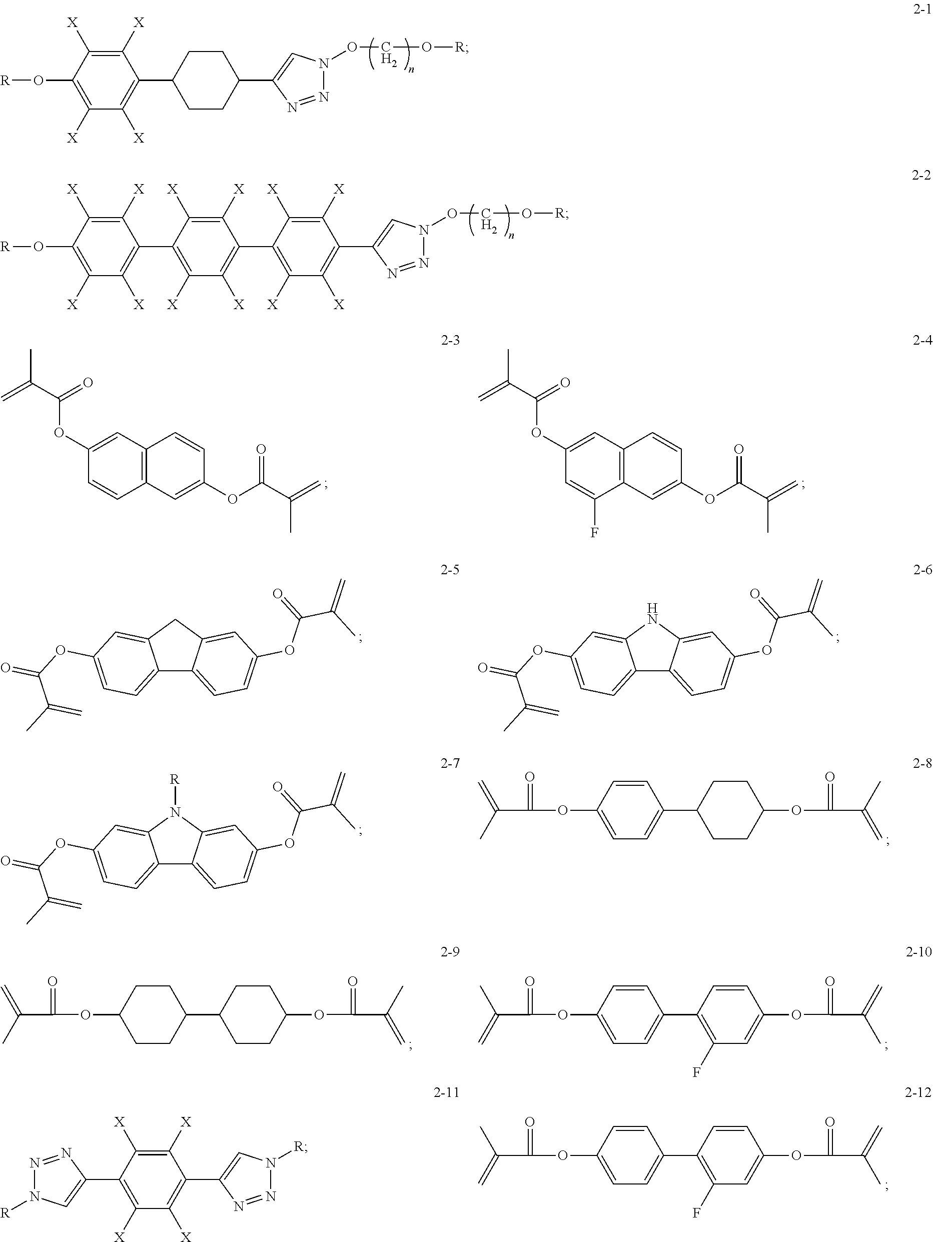 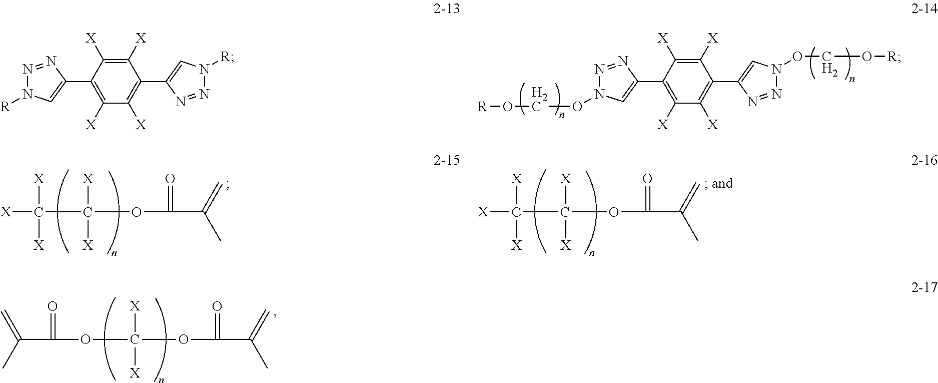
wherein, in Chemical Formulas 2-1 to 2-17,
n is 1 to 20,
X is at least one functional group selected from hydrogen, fluorine, chlorine, bromine, iodine, an amine group and a hydroxide group, and
R is at least one compound selected from

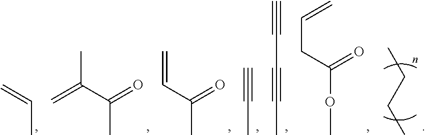

16. The method of claim 12, wherein the formation of the protrusion by irradiating ultraviolet rays to the mixture of the liquid crystal molecule and the reactive mesogen comprises:
irradiating first ultraviolet rays in a state of a non-electric field; and
irradiating second ultraviolet rays in a state of an electric field to form a pretilt angle.

17. The method of claim 16, further comprising, after irradiating the second ultraviolet rays in a state of an electric field to form the pretilt angle, irradiating a fluorescence ultraviolet light to remove non-reacted reactive mesogen in the plurality of microcavities.

18. The method of claim 16, wherein the pretilt angle after irradiating the second ultraviolet rays in a state of an electric field to form the pretilt angle is about 1 degree to about 2 degrees.

19. The method of claim 17, wherein a content of reactive mesogen in the liquid crystal layer after irradiating ultraviolet rays to the mixture of the liquid crystal molecule and the reactive mesogen to form the protrusion is less than about 150 parts per million.

20. The method of claim 12, further comprising forming a capping layer on the roof layer between the injecting of the mixture of the liquid crystal molecule and the reactive mesogen into the plurality of microcavities and the irradiation of ultraviolet rays onto the mixture of the liquid crystal molecule and the reactive mesogen to form the protrusion.
